(19) United States
(12) Patent Application Publication
(10) Pub. No.: US 2025/0181652 A1
(43) Pub. Date: Jun. 5, 2025

(54) DATASET MULTIPLEXER WITH DATASET RESOLVER FOR DATA PROCESSING SYSTEM

(71) Applicant: Ab Initio Technology LLC, Lexington, MA (US)

(72) Inventors: Amit Weisman, Bedford, MA (US); Cory Christopher James Fantasia, East Walpole, MA (US); Robert Parks, Weston, MA (US); Matthew Austin Eads, Cambridge, MA (US); William Robert Zimmerman, Framingham, MA (US); Aaron Huang, Burlington, MA (US); Matthew Douglas Becker, Roslindale, MA (US)

(73) Assignee: Ab Initio Technology LLC, Lexington, MA (US)

(21) Appl. No.: 18/961,714

(22) Filed: Nov. 27, 2024

Related U.S. Application Data
(60) Provisional application No. 63/723,104, filed on Nov. 20, 2024.
(60) Provisional application No. 63/605,428, filed on Dec. 1, 2023.

(51) Int. Cl. G06F 16/908; G06F 16/901

(52) U.S. Cl. CPC G06F 16/908; G06F 16/901

(57) ABSTRACT

A data processing system with a dataset multiplexer that enables applications to be written to specify access to datasets as operations on logical datasets. During execution of an application by the data processing system, the physical dataset used for performing data access operations may be selected based on current context. Current context may be specified based on values of system parameters and/or user specified values. The physical dataset accessed may be identified by selecting a record from multiple records in a dataset catalog associated with the logical dataset. Each record includes information to access a physical dataset associated with the selected record and context information to indicate the context in which the specific physical dataset is to be selected.

### CROSS-REFERENCE TO RELATED APPLICATIONS

This application claims priority to and the benefit of U.S. Provisional Patent Application No. 63/723,104, filed on Nov. 20, 2024, entitled “DATASET MULTIPLEXER WITH DATASET RESOLVER FOR DATA PROCESSING SYSTEM.” This application also claims priority to and the benefit of U.S. Provisional Patent Application No. 63/605,428, filed on Dec. 1, 2023, entitled “DATASET MULTIPLEXER WITH DATASET RESOLVER FOR DATA PROCESSING SYSTEM.” The contents of these applications are incorporated herein by reference in their entirety.

### FIELD

Aspects of the present disclosure relate to techniques for efficiently operating a data processing system with a large number of datasets that may be stored in any of a large number of data stores.

### BACKGROUND

Modern data processing systems manage vast amounts of data within an enterprise. A large institution, for example, may have millions of datasets. This data can support multiple aspects of the operation of the enterprise such that having such a large number of datasets may be invaluable to the enterprise. Some datasets, for example, may support routine processes, such as tracking customer account balances or sending account statements to customers. In other instances, processing the data from one or more datasets may generate business insights, such as a conclusion that a requested transaction is fraudulent or that the enterprise is exposed to a particular level of financial risk as a result of transactions in the aggregate in a particular geographic region. In yet other instances, processing the data from one or more datasets may generate technical insights, such as a conclusion that the enterprise is exposed to a risk of technical failure as a result of an incorrect technical process.

Physical storage for these datasets may be provided in any of a number of ways. For example, a dataset might be stored in a structured way and managed by a database system within the enterprise. In this case, a dataset might be stored as one or more tables managed by the database. Alternatively, simple datasets might be stored in files that the data processing system can access, such as a .csv or .xml file or a flat file. The computer storage on which a dataset resides, whether as a file, a database table or in some other format, may be implemented physically in any of a number of forms, such as local to the data processing system, distributed throughout the enterprise or distributed throughout a network cloud managed by a third party.

An enterprise architect may select physical storage for a dataset based on anticipated characteristics of that dataset, such as size of the dataset, required access time, length of time the dataset is to be retained or impact to the enterprise as a result of loss or corruption of the dataset. Commercial considerations, such as price of storage or concerns about being locked into a third party storage vendor, may also impact choices made in implementing physical storage for an enterprise. As a result, data stores holding the datasets used within an enterprise may take any of multiple forms.

To support a wide range of functions, a data processing system may execute applications, whether to implement routine processes or to extract insights from the datasets. The applications may be programmed to access the data stores to read and write data.

### SUMMARY

Some embodiments provide a method, performed by a data processing system, for generating and/or using entries in a dataset catalog to enable access to physical datasets in data stores, wherein the data processing system is configured to execute data processing applications programmed to access logical datasets, the method comprising: creating a plurality of records in the dataset catalog, wherein each record of the plurality of records is associated with a physical dataset and has associated therewith computer-executable instructions for accessing the physical dataset and at least two of the plurality of records are associated with a first logical dataset; receiving input identifying, at least in part, the first logical dataset for accessing to perform an operation within a data processing application specifying access to a dataset; upon execution of the operation within the data processing application: selecting a record from the at least two of the plurality of records associated with the first logical dataset; and invoking the computer-executable instructions for accessing a physical dataset associated with the selected record in the dataset catalog.

In some embodiments, each record of the plurality of records is associated with a physical dataset comprises context information associated with the physical dataset.

In some embodiments, the context information includes information identifying an environment in which the physical dataset is used. The information identifying the environment indicates one of a development environment, a test environment or a production environment.

In some embodiments, the context information includes information identifying a type of a data processing application that accesses the physical dataset. The information identifying the type of the data processing application indicates one of a batch application or a continuous application.

In some embodiments, the context information includes one or more labels. In some embodiments, the one or more labels is a text string. The text string may indicate a size of the physical dataset. The text string may indicate origin information of the physical dataset.

In some embodiments, the context information includes information identifying one or more users.

In some embodiments, the method further includes for a record of the plurality of records associated with a physical dataset: receiving the context information through a user interface; and conditionally storing the received context information in the dataset catalog such that the context information is associated with the physical dataset.

In some embodiments, the physical dataset is associated in the dataset catalog with a logical dataset; and conditionally storing the received context information in a record of the plurality of records in the dataset catalog comprises: determining whether the dataset catalog contains a record associated with the logical dataset having the same context information; storing the context information when it is determined that the dataset catalog does not contain a record associated with the logical dataset having the same context information; and indicating an error when it is determined that the dataset catalog does contain a record associated with the logical dataset having the same context information.

In some embodiments, the at least two of the plurality of records associated with the first logical dataset comprises a first record associated with a first physical dataset and a second record associated with a second physical dataset, the first record comprises first context information associated with the first physical dataset, and the second record comprises second context information associated with the second physical dataset.

In some embodiments, selecting a record from the at least two of the plurality of records associated with the first logical dataset comprises: identifying a context associated with the operation within the data processing application; selecting the first record when the context associated with the operation corresponds to the first context information associated with the first physical dataset; and selecting the second record when the context associated with the operation corresponds to the second context information associated with the second physical dataset.

In some embodiments, the method further includes identifying an ambiguity when both the first and the second records are identified for selection; and providing a user interface through which a user provides input to resolve the ambiguity.

In some embodiments, invoking the computer-executable instructions comprises enabling access to the selected record in the dataset catalog; and enabling access, based on information within the selected record, to a data store storing the physical dataset associated with the selected record in the dataset catalog.

Some embodiments provide a method for configuring a data processing system to facilitate access to a plurality of physical datasets in data stores, wherein the data processing system comprises a dataset multiplexer, the method comprising: configuring the dataset multiplexer of the data processing system to provide an application with access to a physical dataset of the plurality of physical datasets at least in part by: receiving information relating to the plurality of physical datasets stored in one or more data stores, wherein at least two of the plurality of physical datasets correspond to a first logical dataset; receiving context information for each physical dataset of the plurality of physical datasets; and storing the context information in a plurality of records in a dataset catalog, wherein each record of the plurality of records is associated with a physical dataset, and wherein storing the received context information comprises: storing, in a first record in a dataset catalog, first context information for a first physical dataset of the at least two of the plurality of physical datasets; and storing, in a second record in the dataset catalog, second context information for a second physical dataset of the at least two of the plurality of physical datasets.

In some embodiments, each of the plurality of records in the dataset catalog comprises a plurality of fields representing the context information; and at least some of the plurality of fields are configured to store a value of a set of enumerated values.

In some embodiments, the plurality of fields comprises: a first field configured to store a value from an enumerated set of values indicating a type of application; a second field configured to store a value from an enumerated set of values indicating an environment of the data processing system; and a third field configured to store a label.

In some embodiments, the dataset multiplexer comprises the dataset catalog storing information for access to the plurality of physical datasets.

In some embodiments, the first record further comprises a link to a first program to enable the application to access the first physical dataset with the first program and the second record further comprises a link to a second program to enable the application to access the second physical dataset with the second program.

In some embodiments, the first record further comprises values of parameters accessed in execution of the first program; and the second record further comprises values of parameters accessed in execution of the second program.

Some embodiments provide a method, performed by a data processing system, for using entries in a dataset catalog to enable an application to access a plurality of physical datasets in a plurality of data stores, the method comprising: providing a user interface through which a user identifies, at least in part, a logical dataset for accessing in the application; and executing the application and, upon execution of an operation involving access to the identified logical data set: selecting a record from at least two of a plurality of records associated with the logical dataset; and enabling access, based on information within the selected record, to a data store storing the physical dataset associated with the selected record.

In some embodiments, the at least two of the plurality of records associated with the logical dataset comprises a first record associated with a first physical dataset and a second record associated with a second physical dataset, the first record comprises first context information associated with the first physical dataset, and the second record comprises second context information associated with the second physical dataset.

In some embodiments, selecting the record from the at least two of a plurality of records associated with the logical dataset comprises: identifying a context associated with the operation involving access to the identified logical data set; selecting the first record when the context associated with the operation corresponds to the first context information associated with the first physical dataset; and selecting the second record when the context associated with the operation corresponds to the second context information associated with the second physical dataset.

In some embodiments, identifying a context associated with the operation involving access to the identified logical data set comprises prompting a user to provide input indicating a value of a parameter comprising a portion of the context associated with the operation.

In some embodiments, prompting the user to provide input indicating the value of a parameter comprising a portion of the context associated with the operation comprises presenting a list populated with values from the dataset catalog; and the values from the dataset catalog are stored in records in the dataset catalog associated with the logical dataset.

In some embodiments, identifying a context associated with the operation involving access to the identified logical data set comprises providing a value indicative of an environment of the data processing system in which the application is invoked. The value indicative of the environment is one of development, test, or production.

In some embodiments, identifying a context associated with the operation involving access to the identified logical data set comprises providing a value indicative of a type of the application. The value indicative of the type of application is one batch or continuous.

In some embodiments, identifying a context associated with the operation involving access to the identified logical data set comprises determining that a user specifiable parameter associated with the application lacks a value; and based on the determination, prompting a user to provide input indicating a value of the user specifiable parameter.

In some embodiments, the selected record comprises context information associated with the physical dataset.

In some embodiments, the context information comprises at least a first type of context and a second type of context, and wherein selecting the record comprises determining whether to select the record based on evaluation of the first type of context; and when the record is not selected based on the evaluation of the first type of context, determining whether to select the record based on evaluation of the second type of context.

### BRIEF DESCRIPTION OF DRAWINGS

Various aspects will be described with reference to the following figures. It should be appreciated that the figures are not necessarily drawn to scale. Items appearing in multiple figures are indicated by the same or a similar reference number in all the figures in which they appear.

FIG. 1A is a block diagram of an exemplary enterprise IT system with a data processing system having a dataset multiplexer according to an aspect of the technology described herein;

FIG. 1B is a block diagram of the exemplary enterprise IT system of FIG. 1A in an operating state in a first context in which the dataset multiplexer facilitates access between an application, configured to access a logical dataset, and a first data store storing a physical dataset corresponding to the logical dataset;

FIG. 1C is a block diagram of the exemplary enterprise IT system of FIG. 1B in an operating state in a second context in which the dataset multiplexer facilitates access between the application, configured to access the logical dataset, and a second data store storing the physical dataset corresponding to the logical dataset;

FIG. 2 is a block diagram of an exemplary enterprise IT system with a data processing system having a dataset multiplexer and a dataset resolver according to an aspect of the technology described herein;

FIG. 3A is a schematic illustration of a graphical development environment for an application written as a data flow graph;

FIG. 3B is a schematic illustration of the dataflow graph of FIG. 3A, where an input node of the dataflow graph is configured or programmed in terms of a logical dataset;

FIG. 3C is a schematic illustration of the data flow graph of FIG. 3A in a development environment, modified to access information in a dataset catalog to enable access to a physical dataset for execution of operations in the application specifying access to a logical dataset;

FIG. 3D is a schematic illustration of the data flow graph of FIG. 3A in a production environment, modified to access information in a dataset catalog to enable access to a physical dataset for execution of operations in the application specifying access to a logical dataset;

FIG. 4A is a schematic illustration of information that may be reflected in an object of a dataset catalog providing information about physical dataset(s) corresponding to a logical dataset;

FIG. 4B is an alternative schematic illustration of information that may be reflected in an object of a dataset catalog providing information about physical dataset(s) corresponding to a logical dataset;

FIG. 5A is a block diagram of the exemplary enterprise IT system of FIG. 1A, showing additional details of a dataset multiplexer in which programs for accessing data sources are illustrated as dynamic subgraphs (DSG);

FIG. 5B is a block diagram of the exemplary IT system of FIG. 1A, showing a dataset resolver of a data multiplexer that enables selection of a first record in a dataset catalog that is associated with a logical dataset;

FIG. 5C is a block diagram of the exemplary IT system of FIG. 1A, showing a dataset resolver of a data multiplexer that enables selection of a second record in a dataset catalog that is associated with a logical dataset;

FIG. 6 is a block diagram illustrating information used in a data processing system configured with a dataset multiplexer according to some aspects of the technology described herein;

FIG. 7 is a flowchart of an exemplary method of operating a data processing system with a dataset multiplexer and a dataset resolver according to an aspect of the technology described herein; and

FIGS. 8A-8B illustrate example user interfaces that enable a user to designate logical dataset and a selection mode for a corresponding physical dataset according to some aspects of the technology described herein.

FIGS. 9A-9D illustrates example user interfaces that provide information regarding the one-to-many mapping between a logical dataset and multiple physical datasets according to some aspects of the technology described herein.

FIG. 10 is a block diagram of an illustrative computing system environment that may be used in implementing some aspects of the technology described herein.

### DETAILED DESCRIPTION

The inventors have recognized and appreciated that a dataset multiplexer that selects a physical dataset to access based on context may enable efficient operation of a data processing system. In an enterprise with many datasets that may be stored in a variety of data stores, the dataset multiplexer enables the use of applications written in terms of one or more logical datasets rather than written in terms of physical datasets. By providing a dataset multiplexer that recognizes context, a different physical dataset may be associated with the same logical dataset in different contexts.

A dataset catalog may maintain information about one or more physical datasets to associate with the logical dataset such that, when an application executes a data access operation specified for the logical dataset, the dataset multiplexer may access the catalog to obtain information indicating the appropriate physical dataset for the current context. That information may include the context in which each physical dataset is to be associated with the logical dataset.

Context may be specified with values of one or more parameters. A set of parameters defining context may include one or more system parameters and/or one or more user defined parameters. Values of system parameters may be based on the state of the data processing system at the time access to a dataset is made through the data multiplexer. Current values for these parameters may be determined automatically without any user action in some implementations. System parameters may include, for example, the operational environment of the data processing system, a type of application accessing the dataset, a user of the system, or other information maintained as part of the operation of the data processing system.

User defined parameters may be based on values specified directly or indirectly by a user. Such values, for example, may be specified as inputs to an application when it is written or invoked for execution. As a specific example, the user defined parameters may be labels, such as text strings, associated with portions of an application that perform data access operations such that they may be passed to the dataset multiplexer when a request for access to data associated with a logical dataset is made.

As an example of system context parameters, a parameter may indicate a phase in the system development life cycle. Alternatively or additionally, different environments may be used at different times and the environment in use may be indicated by a system context parameter. As a specific example, a data processing system may support environments such as a development environment, a test environment and a production environment. An application may be developed in a development environment, tested in one or more test environments and then promoted to a production environment. In the production environment, the application may read and write to one or more data stores with “live” data used throughout the enterprise. In the test and development environments, the application may be operated with offline data stores that, if corrupted by improper operation of the application, are unlikely to impact the enterprise. In the development environment, the data stores may be relatively small while in the test environment the data stores may be structured to provide robust test cases, including extreme test cases that might not appear in the current live data. From the perspective of the application, physical datasets in each of these disparate physical datastores may be considered as the same logical dataset, as any of them may provide data for processing. These physical datasets may be registered in the dataset catalog such that there is a record for each in the dataset catalog which is associated with the same logical dataset.

Within the record for each of the physical datasets, for example, may be a different value of an environment context parameter, indicating whether the physical dataset is live data, a test dataset or a more constrained development dataset. Accordingly, the environment context parameter may take on one of a set of enumerated values, such as development, test or production. Optionally, the set of enumerated values may include a value indicating “don't care,” meaning that the dataset is not configured for any environment specifically.

The dataset catalog may support mapping of a logical dataset to any of multiple physical datasets (e.g., a one-to-many mapping). For example, the dataset catalog may include multiple catalog records for one logical dataset, where each record corresponds to a particular programming environment and includes information for accessing data from a physical dataset used in that programming environment. In this way, an application written to access logical datasets may operate in any of the environments and automatically access the appropriate data store when executed in each environment without the need to adapt the application to the particular environment.

When execution of the application involves an operation on a logical dataset, the data processing system automatically utilizes the appropriate data catalog information for the appropriate environment to access the data store containing the physical dataset in that environment storing data corresponding to the logical dataset. The dataset multiplexer may compare current context information with context information in the dataset catalog associated with specific physical datasets in order to select one of the physical datasets for access.

As another example of a system context parameter, different applications may be developed to operate on different types of data. Some applications, for example, may be coded to operate on batch data, whereas others may be coded to operate on continuous data. The type of data that an application is coded to process—batch or continuous in this example—may be used as the value of a system context parameter indicating type. In a data processing system that stores such information, the value of the type parameter may be read from system information. As with other context parameters, the parameter optionally may be implemented such that it takes on a value from an enumerated set of values, and that set optionally may include a “don't care” value.

The type parameter is an example of a context parameter that enables an appropriate physical dataset to be selected for an application such that multiple applications of different type may all be programmed to access the same logical dataset. Accordingly, a dataset multiplexer that operates with a dataset catalog that supports one to many mappings between logical datasets and multiple physical datasets is not limited to supporting use of different physical datasets at different times for the same application. Rather, it may automate the selection of an appropriate physical dataset for different applications.

As a specific example of how a type parameter may enable efficient operation of a data processing system, within a retail enterprise, multiple applications may be written to access sales data. That sales data may arrive at a central office in real time, such that it may be regarded as continuous. That continuous flow of sales data may be an input data source for an application. Such an application may be written to process that data as it arrives and therefore may be regarded as a continuous application. Additionally, within the enterprise the sales data may be cleaned or otherwise processed and some or all of it may be stored in a database. Other applications may be written to access the sales data from the database, and those applications may be regarded as batch applications. Despite multiple sources for the sales data, all of the applications may be written in terms of the same logical dataset for sales data. By using context such as an application type parameter, the dataset multiplexer may select the appropriate physical dataset for each application that requests access to sales data.

By supporting a flexible definition of context, the dataset multiplexer may select appropriate physical datasets to associate with logical datasets in a wide range of scenarios that are important to an enterprise. Context may be represented by values of multiple parameters for example such that there may be a large number of different contexts supported.

Those parameters may alternatively or additionally include a parameter accepting values that provide information about a user. Such information may define a user persona, such as a specific user, or a class of users based on their role or position within an enterprise, for example. As a specific example, data related to customers may contain information that is used only within certain portions of an enterprise, such that access to portions of a dataset storing customer information may be limited based on persona of a user to only those users associated with those portions of the enterprise. Accordingly, many users may access a logical dataset for customer data, but it may be desirable to either provide that data from different physical datasets that may contain only portions of the data relevant to specific portions of the enterprise or to provide a different access mechanism to the same physical dataset based on persona of the user. Records in a dataset catalog associated with logical datasets and defining access to a physical dataset when that logical dataset is to be accessed can be configured to control either which physical dataset is accessed or the manner in which a physical dataset is accessed. Accordingly, using current context information to select one of multiple such records associated with the same logical dataset enables control over which physical dataset is accessed and/or the manner in which it is accessed.

Context may be flexibly specified by supporting user defined parameters as part of the definition of context. As a specific example, context may include one or more parameters that act as labels. These parameters, for example, may accept values formatted as text strings or in some other format that enables the parameter to take on any of a large number of values. As a specific example, a label may take on values that indicate a size of a database or an origin of a physical database. Origin, for example, may designate a portion of an enterprise. A size label, for example, may store values representing size numerically or may be one of a set of enumerated values, such as small, medium or large. Such a size context parameter may be used when an application is written for efficient operation on datasets of a specific size or to differentiate scenarios in which a fast answer versus a comprehensive answer is required.

Alternatively or additionally, values for one or more labels supported by the system may come from sources other than user input, such as other tools or programs within an enterprise. These values need not be predefined, and the definition of current context may be flexible enough to represent a large number of scenarios of interest to a business.

With a dataset multiplexer as described herein, a business user who has no knowledge of the physical datasets and the data stores but understands how to extract business insights from data, for example, is enabled to write applications in terms of logical datasets rather than in terms of physical datasets. The dataset multiplexer may automatically supply connections between the applications and the data stores storing the physical datasets represented by the logical datasets that are appropriate for the current context, avoiding the need for the application and the user to have knowledge of the implementation of the data stores.

A data processing system may have a registration component for physical datasets to build a catalog of logical datasets. As part of the registration process controlled by such a component, information may be obtained about each physical dataset (such as from user input) and stored in a record. That information may include a program that may be executed to access the physical dataset and/or reformat the data accessed in the physical dataset. One or more records, each representing a physical dataset, may be associated with a logical dataset for which there is an entry in the catalog. Additionally, the registration component may collect information about the context in which each of the datasets associated with a logical dataset is to be selected when that logical dataset is accessed. In implementations in which context is represented by values of one or more context parameters, this information may be a set of values for the context parameters. However, context may be specified in other ways, such as ranges of values of context parameters or rules or heuristics that may be applied based on information representing context, for example.

The registration component may be configured to reduce errors. It may as part of registering a physical dataset associated with a logical dataset confirm that there are no other physical datasets already associated with that logical dataset and specified for use in the same context. The registration component may indicate an error if two physical datasets with the same values of context parameters are associated with the same logical dataset. By blocking the registration of physical datasets that would create ambiguity as to which should be selected in a particular context, errors may be reduced.

Alternatively or additionally, errors may be identified at runtime, which may lead to corrective action, such as prompting a user to change, complete, or override information in the dataset catalog used to select a physical dataset for data access specified for a logical dataset. Scenarios requiring corrective action, for example, may be identified by a resolver component, if there is either no physical dataset specified for use in the current context by an application accessing a logical data set or if there are multiple physical datasets specified. Optionally, in such scenarios, the corrective action may include selecting a physical dataset indicated as a “Default” dataset.

Additional details of a dataset multiplexer are described in US-2022-0245125-A1, which is hereby incorporated by reference in its entirety.

Aspects of a data processing system may be implemented to achieve any or more the foregoing objects and advantages. These objects and advantages may be used alone or together in any suitable combination.

Representative Data Processing System with a Dataset Multiplexer

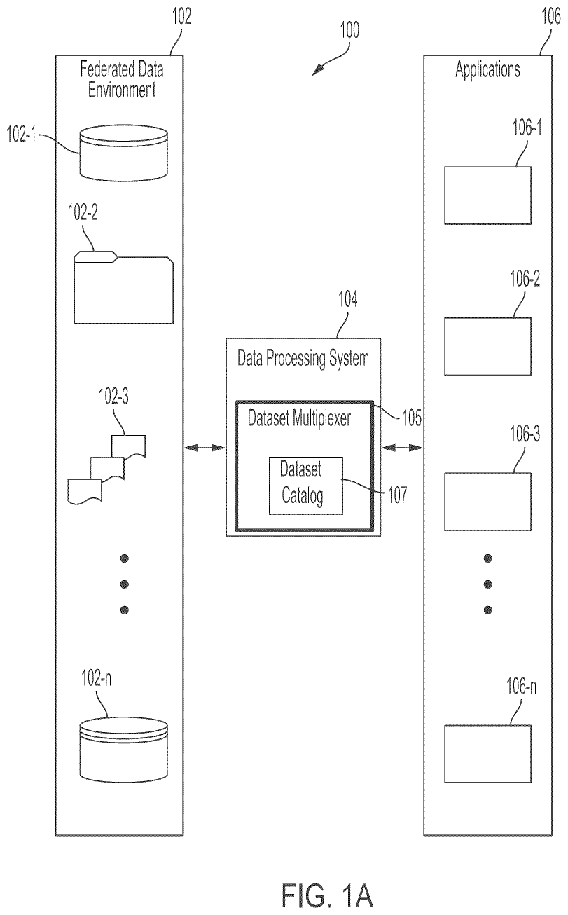

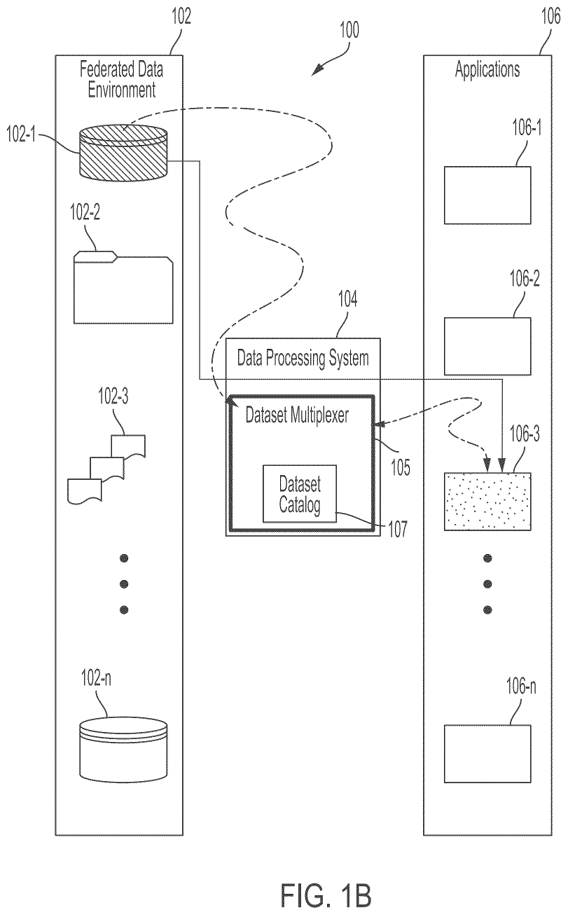

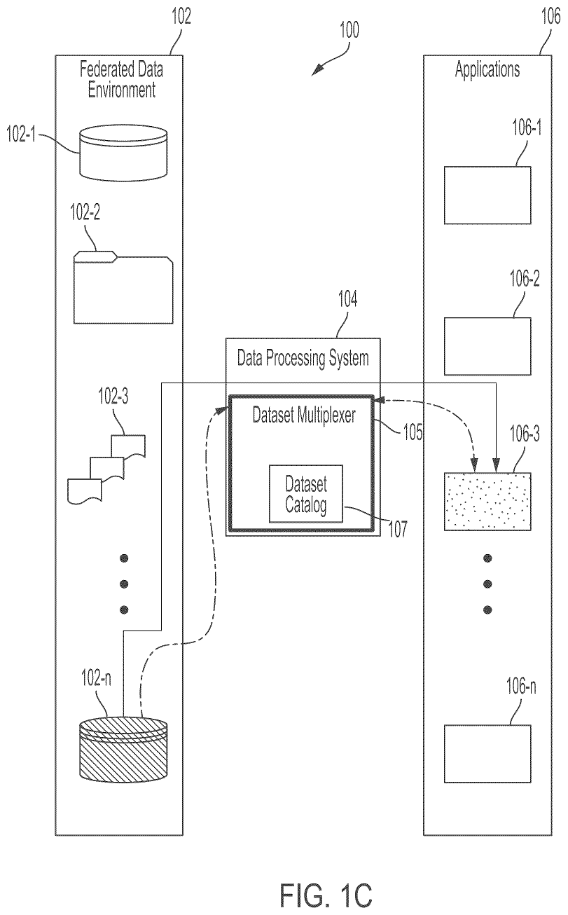

FIG. 1A is a block diagram of an IT system 100 including an illustrative data processing system 104 and a dataset multiplexer 105 integrated with the data processing system 104, in accordance with some aspects of the technology describes herein. IT system 100, for example, may be an IT system of an enterprise, such as a financial company. For simplicity, elements of an enterprise IT system, such as networks, cloud storage, and user devices, are not expressly shown.

Data processing system 104 is configured to access (e.g., read data from and/or write data to) data stores 102-1, 102-3, 102-3, . . . , and 102-n. Each of the data stores 102-1, 102-3, 102-3, . . . , and 102-n, may store one or more physical datasets. A data store may store any suitable type of data or collection of data in any suitable way or format. A data store may store data as a flat text file, a spreadsheet, using a database system (e.g., a relational database system), for example. Moreover, these data stores may be internal or external to the enterprise. External data stores, for example, may be “in the cloud,” or otherwise in storage hardware managed by a third party. Accordingly, the data stores may provide a federated environment in which different data stores used by an enterprise may be in different locations and/or managed by different entities inside or outside the enterprise.

In some instances, a data store may store transactional data. For example, a data store may store credit card transactions, phone records data, or bank transactions data. It should be appreciated that data processing system 104 may be configured to access any suitable number of data stores of any suitable type, as aspects of the technology described herein are not limited in this respect. A data store from which data processing system 104 may be configured to read data may be referred to as a data source. A data store to which data processing system 104 may be configured to write data may be referred to as a data sink. However, techniques as described herein may be applied to data stores holding other types of data that are used in an enterprise.

Each data store may be implemented with one or multiple storage devices and may include data management software or other control mechanism to support the storage of physical datasets in one or more formats of any suitable type. The storage device(s) may be of any suitable type and may include, for example, one or more servers, one or more disc arrays, one or more clusters of disk arrays, one or more portable storage devices, one or more non-volatile storage devices, one or more volatile storage devices, and/or any other device(s) configured to store data electronically. In embodiments where a data store includes multiple storage devices, the storage devices may be co-located in one physical location (e.g., in one building) or distributed across multiple physical locations (e.g., in multiple buildings, in different cities, states, or countries). The storage devices may be configured to communicate with one another using one or more networks of any suitable type, as aspects of the technology described herein are not limited in this respect.

The data management software may organize the data in physical storage and provide a mechanism to access the data such that data may be written to or read from physical storage. The data management software may be, for example, a database system or a file management system. Depending on the type of data management software, the storage device(s) may store physical datasets using one or more formats such database tables, spreadsheet files, flat text files, and/or files in any other suitable format (e.g., a native format of a mainframe). The data stores 102-1, 102-2, 102-3, . . . , and 102-n may be of a same type (e.g., all may be relational databases) or different types (e.g., one may be a relational database while another may be a data store that stores data in flat files). When the data stores are of different types, the storage environment may be referred to as a heterogenous or federated data environment 102. A data store may be, for example, a SQL server database, an ORACLE database, a TERADATA database, a flat file, a multi-file data store, a HADOOP distributed database, a DB2 data store, a Microsoft SQL SERVER data store, an INFORMIX data store, a table, collection of tables or other subpart of a database, and/or any other suitable type of data store, as aspects of the technology described herein are not limited in this respect.

Data processing system 104 supports a wide variety of applications 106 to perform functions that access (e.g., read and/or write access) physical datasets stored in data stores 102-1, 102-3, 102-3, . . . , and 102-n. Applications 106 may then perform operations based on data in the data stores. Data processing system 104 may support applications 106-1, 106-2, 106-3, . . . , and 106-n that may be of a same type or different types. In some instances, an application may, when executed, read or write transactional data to or from one or more physical datasets in a data store. In other instances, an application may, when executed, read or write data to or from physical datasets stored across different data stores and analyze the data in order to extract business insights from the datasets.

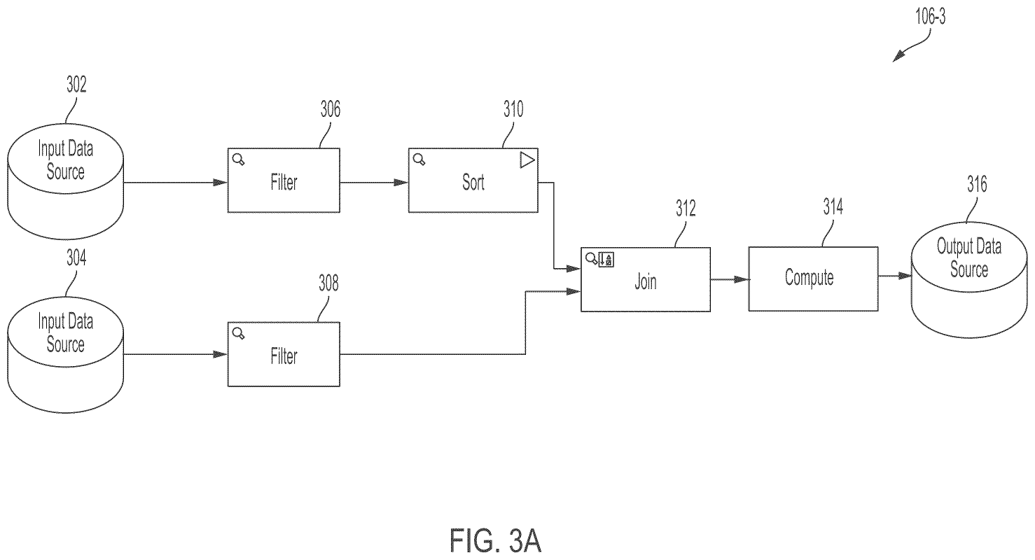

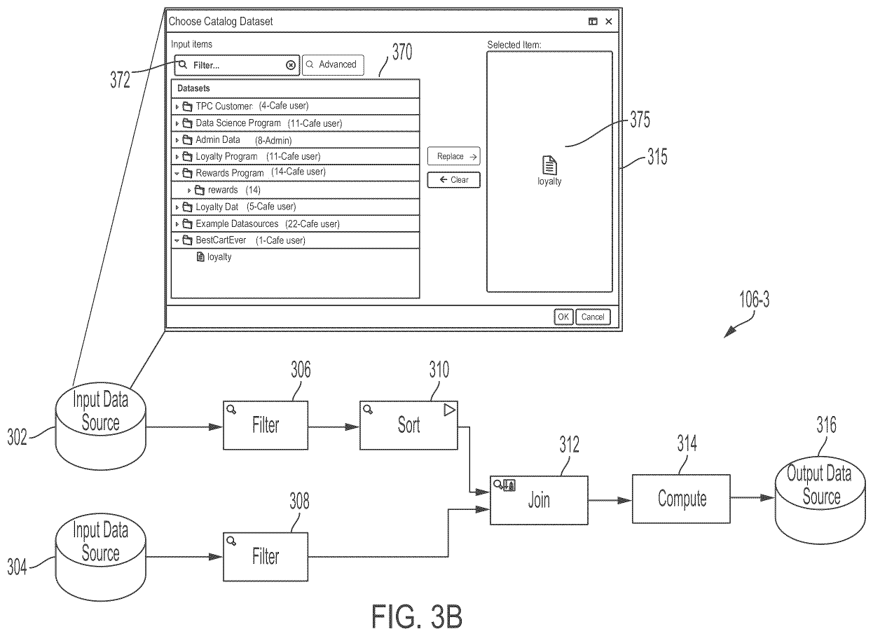

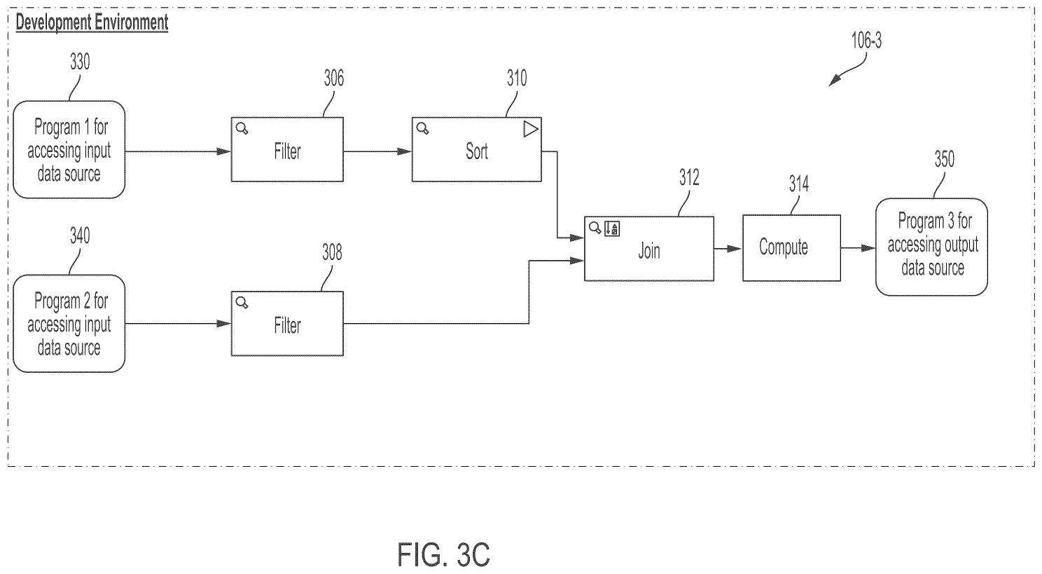

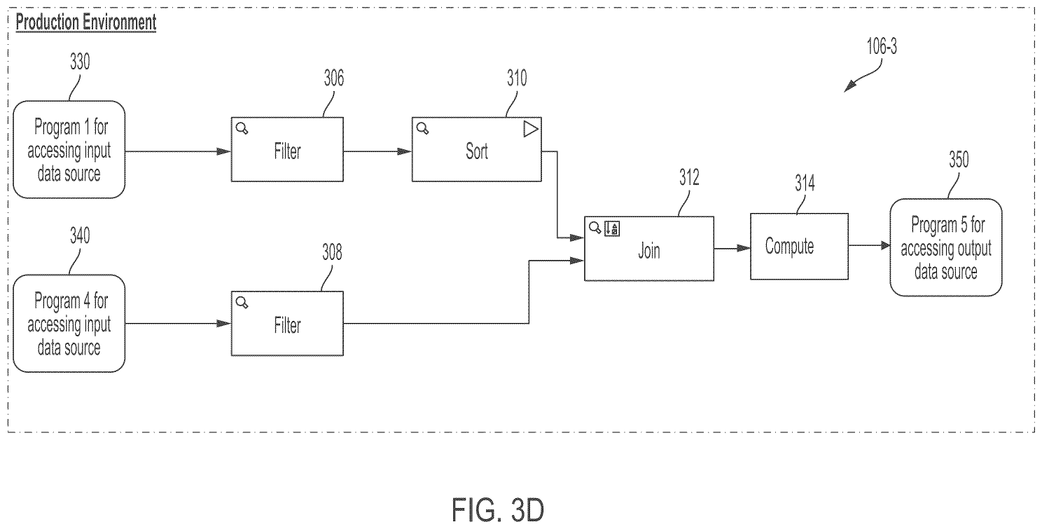

Applications 106 may be developed as data flow graphs, as shown in FIG. 3A, for example. A dataflow graph may include components, termed “nodes” or “vertices,” representing data processing operations to be performed on data and links between the components representing flows of data. Techniques for executing computations encoded by dataflow graphs are described in U.S. Pat. No. 5,966,072, titled “Executing Computations Expressed as Graphs,” which is incorporated by reference herein in its entirety. An environment for developing applications (e.g., computer programs) as data flow graphs is described in U.S. Pat. Pub. No.: 2007/0011668, titled “Managing Parameters for Graph-Based Applications,” which is incorporated by reference herein in its entirety. The dataflow graph may include data sources (such as input data stores 302 or 304, FIG. 3A) and data sinks (such as output data store 316, FIG. 3A). These are represented by terminal nodes in the flows that signify access to a data store 102-1, 102-3, 102-3, . . . , or 102-n.

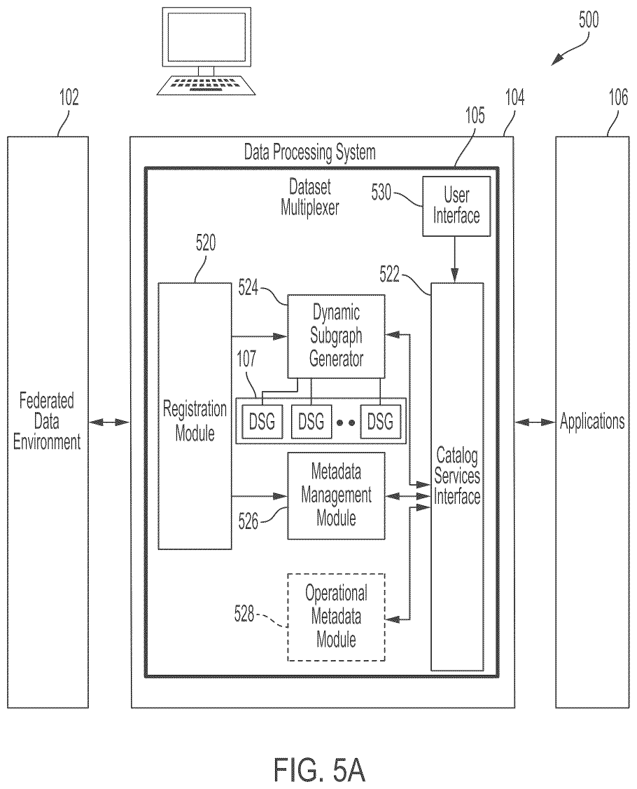

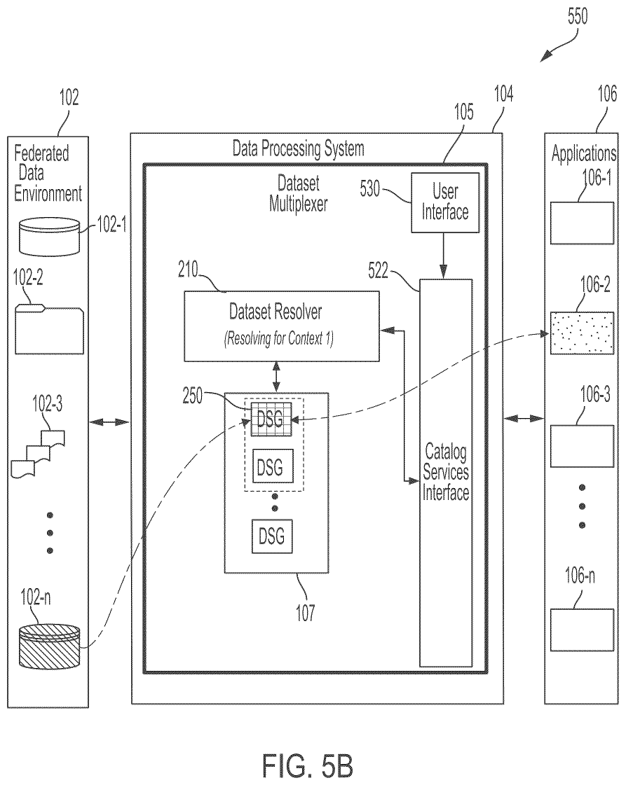

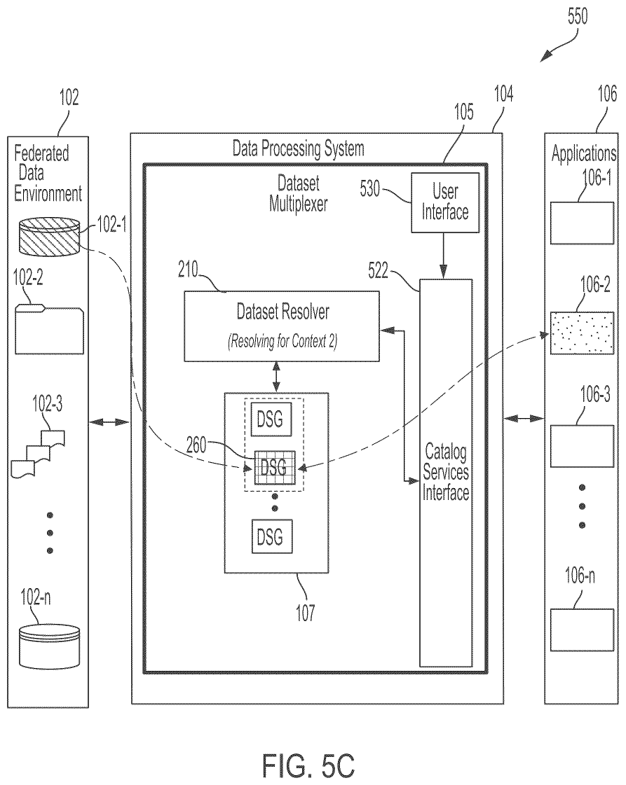

However, the application itself need not be programmed with the specific data store included in the application. Rather than being hard coded to access a single physical dataset, applications 106 may be programmed in terms of logical datasets. A logical dataset may refer to a logical representation of one or more datasets. The data processing system 104 may store definitions of multiple logical datasets as well as other metadata about those logical datasets. This information may be managed, for example, by a metadata management module (e.g., metadata management module 526, FIG. 5A). Tools used with data processing system 104 may access metadata about logical datasets and perform functions based on that metadata. For example, a program development environment may provide a user interface through which available logical datasets may be selected and used in programming an application.

A logical dataset may have a schema that defines data independently of the format of the corresponding data in any of the physical datasets/data stores mapped to the logical dataset. A logical dataset, for example, may have a schema that defines logical entities in the logical dataset. The logical entities may be recognizable and/or understandable to a human user. For example, a logical dataset may include a logical entity such as customer name. In a first physical dataset corresponding to this logical dataset, a customer name might be stored as three fields in a row of a data table, holding data corresponding to the customer's first name, middle initial and last name, respectively. In a second physical dataset corresponding to this logical dataset, a customer name might be stored as two fields in a row of a data table, holding data corresponding to the customer's first name and last name, respectively. The logical dataset, however, may simply include a logical entity Customer_Name without regard to the format of the data in physical storage. As described herein, a dataset multiplexer 105 may be configured with records for each of the physical datasets that each contains information to enable its respective physical dataset to be accessed when it is associated with a logical dataset in order to perform data access operations specified for the logical dataset. Alternatively, each of the physical datasets may have a record format that is compatible with the format of the logical dataset/application that accesses the physical dataset. In other examples, information for accessing a physical dataset may alternatively or additionally be stored in other locations within a data processing system and accessed by a dataset multiplexer 105. As a specific example, information for access to a physical dataset may be stored as part of a project, for example, in which that physical dataset is used.

Data processing system 104 may include an interface (not shown) through which a schema for a logical dataset may be defined. The interface, for example, may be a user interface through which a user may specify or otherwise introduce into the system a logical dataset by specifying its schema. In some embodiments, data processing system 104 may store a set of logical entities that are commonly used in the business of the enterprise. Examples of commonly used logical entities may include one or more of a name, identification number, phone number, address, country of citizenship, account balance, transaction amount, or date. Those business terms may be used to specify, at least partially, the schema of the logical dataset. However, the schema may be defined as including, instead or in addition to predefined logical entities, and other logical entities.

Enabling programing of applications in terms of logical datasets avoids the need for the programmer creating the application to understand the format of the data store storing the corresponding physical data set(s) mapped to the logical dataset. As a result, a data analyst might develop applications using logical datasets, even if that data analyst does not understand the format of data within the data stores holding the physical datasets.

As a more detailed example, within an enterprise a programmer may define a logical dataset storing new customers. The schema for the logical dataset may include logical entities, such as customer name, customer address, customer identifier, and date of customer acquisition, for example. The data analyst may write the application in terms of the logical dataset and these logical entities, regardless of the storage format of the physical dataset(s) corresponding to the logical dataset. As a result, the data analyst may write the application without knowledge of the physical dataset(s) storing data to be accessed by the application.

At the time of execution of the application, data in physical dataset(s) corresponding to the logical dataset may be stored in one or more of the data stores 102-1, 102-3, 102-3, . . . , and 102-n. To execute the application, each operation specifying access to the logical dataset may be executed by data processing system 104 reading or writing data from physical dataset(s) stored in one or more of data stores 102-1, 102-3, 102-3, . . . , and 102-n. In accordance with some aspects, an appropriate physical dataset may be selected from among multiple physical datasets mapped to the logical dataset. As a specific example, that selection may be based on current context information matching context information stored in association with a record in a dataset catalog 107 related to a physical dataset. In accordance with some aspects, dataset multiplexer 105 may enable automated execution of such operations by automatically accessing the selected physical dataset. The access may include converting between the format of data as stored in the physical data store and the format as specified in the schema for the logical dataset. As another example, the conversion may result in associating data from the physical dataset with metadata that has been associated with the logical dataset. As a specific example, the conversion may associate a field from the physical dataset with a field in a logical dataset that is tagged with an indication that it holds personally identifiable information. As a result, the metadata may be used in operations on the data from the physical dataset, such as to filter or mask personally identifiable information, in that example.

As shown in FIG. 1A, data processing system 104 includes dataset multiplexer 105 for automating access to a corresponding physical dataset and conversion between the format for the logical and physical datasets. Dataset multiplexer 105 may maintain a catalog of datasets 107, where each entry in the catalog corresponds to a logical dataset and provides information for accessing one or more physical datasets. The information associated with the one or more physical datasets may specify a context in which that dataset may be selected. For example, a catalog entry may identify one or more physical datasets in data stores 102-1, 102-3, 102-3, . . . , or 102-n corresponding to the logical dataset.

An association in the dataset catalog 107 between a logical dataset and a plurality of physical datasets may be represented in any suitable way. In some embodiments, the dataset catalog 107 may include multiple catalog entries for one logical dataset, where each catalog entry includes a record for storing information for accessing a different physical dataset corresponding to the logical dataset. For example, a first catalog entry for the logical dataset may include a first record for storing information for accessing a physical dataset used in the production environment, a second catalog entry for the logical dataset may include a second record for storing information for accessing a physical dataset used in the test environment, and a third catalog entry for the logical dataset may include a third record for storing information for accessing a physical dataset used in the development environment. In some embodiments, the dataset catalog 107 may include one catalog entry per logical dataset, where the catalog entry includes multiple records for storing information for accessing multiple physical datasets that each correspond to the logical dataset. For example, the catalog entry may include three records for storing information for accessing physical datasets in the production, test, and development environments, respectively.

Regardless of the specific format for storage of information in the dataset catalog 107, each catalog record storing information about a physical dataset may alternatively or additionally include information for accessing the physical dataset and/or converting data as stored in the physical dataset to a format of the logical dataset. That information may be or may include an executable program. For example, catalog information may identify a program for converting data in multiple fields in a physical dataset to the format of a corresponding logical entity in the logical dataset. Other information alternatively or additionally may be stored as or reflected in the catalog record for accessing the one or more physical datasets.

Dataset multiplexer 105 enables applications 106 to seamlessly access physical dataset(s) based on the programmed logical dataset(s) using the information in the catalog of datasets. FIG. 1B illustrates an application (e.g., application 106-3) programmed to access data in accordance with a logical dataset. Upon execution of an operation to access (e.g., read and/or write) a logical dataset, dataset multiplexer 105 of the data processing system 104 may select an appropriate physical dataset for the operation based on the current context and the context information maintained in the dataset catalog 107 for physical datasets associated with the logical dataset and enable access to the selected physical dataset(s) in a data store (e.g., data store 102-1). For example, when the catalog information stored for the logical dataset is or includes an access control program, that program may be executed. As a result, even though application 106-3 is programmed in terms of a logical dataset, when data access operations are executed, a physical dataset stored in data store 102-1 is accessed.

The dataset multiplexer 105 may access its catalog of datasets to identify one or more entries associated with the logical dataset referenced in application 106-3. In embodiments where the dataset catalog includes multiple catalog entries for the logical dataset, the multiple catalog entries may be identified. In other embodiments where the dataset catalog includes one catalog entry for the logical dataset, the one catalog entry may be identified. Regardless of whether multiple catalog entries are identified or a single catalog entry is identified, the information within records associated with the entries is used to select one of these records corresponding to a physical dataset. The information for identifying the physical dataset stored in data store 102-1 and/or converting data in the format of data store 102-1 to the format of the logical dataset may then be used for data access.

FIG. 1C illustrates application 106-3 accessing data store 102-n via the dataset multiplexer 105 of the data processing system 104. The access conditions in FIG. 1B and FIG. 1C may be the result of execution of application 106-3 in different contexts. For example, FIG. 1B shows application 106-3 executing in a development environment indicating that the current context is “development,” and accessing an appropriate physical dataset in data store 102-1, where the dataset multiplexer 105 selects this physical dataset because its context information in the dataset catalog corresponds to the current context. Similarly, FIG. 1C shows application 106-3 executing in a production environment indicating that the current context is “production,” and accessing a different physical dataset in data store 102-n, where the dataset multiplexer 105 selects this physical dataset because its context information in the dataset catalog corresponds to the current context.

In FIG. 1B, a solid line indicates a flow of data from the data store 102-1 to the application 106-3 upon execution of an operation to access (e.g., read and/or write) a physical dataset. Dashed lines indicate interactions between components that may control the flow of data in operation. For example, application 106-3 may interact with dataset multiplexer 105 to obtain information for accessing physical dataset(s) corresponding to a logical dataset from the catalog entry/entries associated with the logical dataset. Dataset multiplexer 105 may obtain information from a corresponding physical dataset(s) in the data store 102-1 to generate the appropriate catalog entry/entries. Similarly, the solid line in FIG. 1C indicates a flow of data from the data store 102-n to the application 106-3 upon execution of an operation to access (e.g., read and/or write) a physical dataset and the dashed lines indicate interactions between components (e.g., dataset multiplexer 105, application 106-3, and data store 102-n) that may control the flow of data in operation.

Dynamically using dataset catalog information for data access may automatically handle selection of appropriate physical datasets for different contexts. For example, a user may run different instances of a data processing system for different purposes. It may be desirable for the same application to access different physical datasets when executing in different instances. Such execution may be ensured by providing catalog information that accounts for the different instances or otherwise where it is desirable for an application to access different physical datasets that correspond to the same logical dataset in different contexts.

The inventors have appreciated that maintaining a one-to-many mapping in the dataset catalog, where one logical dataset may be mapped to multiple physical datasets, enables efficient operation of the data processing system as applications written in terms of logical datasets can be executed by selecting an appropriate physical dataset from among the multiple physical datasets mapped to each logical dataset. This selection is enabled by storing context information associated with physical datasets in the dataset catalog. The dataset catalog may include multiple records for each logical dataset, where each record is associated with a physical dataset and includes context information associated with the physical dataset. For example, the context information may include information identifying an environment in which the physical dataset is used. The information identifying the environment indicates one of a development environment, a test environment or a production environment. As another example, the context information may include information identifying a type of a data processing application that accessed the physical dataset. The information identifying the type of the data processing application indicates one of a batch application or a continuous application. As yet another example, the context information may include one or more labels. Each of the one or more labels may be, for example, a text string that indicates a size of the physical dataset, origin information of the physical dataset, or one or more other characteristics of data in the physical dataset. As a further example, the context information may include information identifying one or more users. The information identifying one or more users indicates a role of users or permissions provided to the users dictating access to data or portions of the data in the physical dataset, and/or other information.

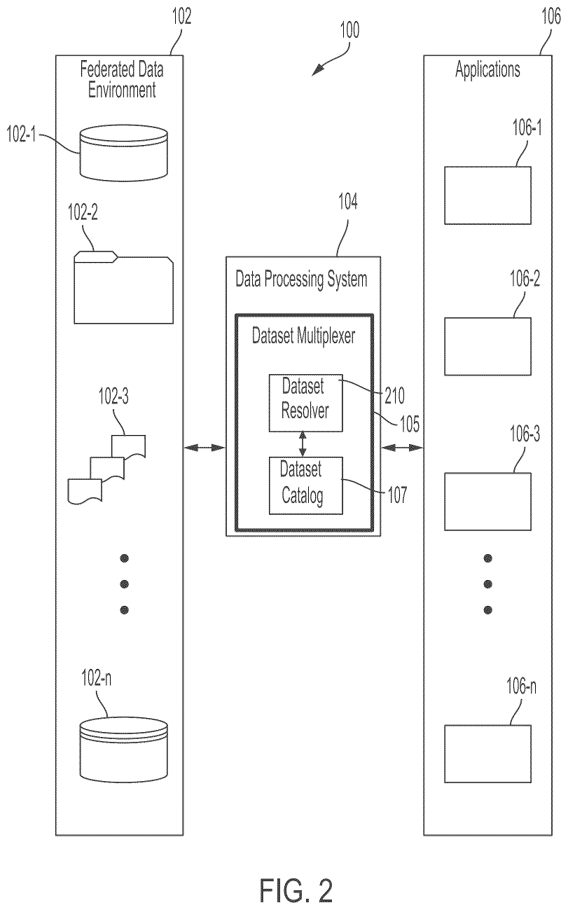

FIG. 2 is a block diagram of an exemplary enterprise IT system with a data processing system having a dataset multiplexer and a dataset resolver, in accordance with some aspects of the technology describes herein. As shown in FIG. 2, the dataset multiplexer 105 includes a dataset resolver 210 that automatically selects one of the physical datasets mapped to a logical dataset using the context information associated with the physical datasets obtained from the dataset catalog 107.

FIG. 1B, for example, may represent operation of a data processing system when first context information is provided to dataset multiplexer resulting in associating data store 102-1 with application 106-3. In a different context, such as is represented by FIG. 1C, context information supplied to data set multiplexer 105 may result in selection of data store 102-n.

According to some aspects, context information may include the environment. The dataset resolver 210 may automatically select an appropriate physical dataset based on the environment the application (e.g., application 106-3) is executing in using the context information stored in the dataset catalog. As a specific example, an enterprise may operate a data processing system in development, test, and production environments. The datasets used by the same application may differ in each of these environments. Live data as is used in the production environment may not be used in either development or test environments to avoid corruption of the live data and/or minimize the risk of exposing sensitive information. The data store for the production environment may be large and provide fast data access, and therefore be very expensive. The dataset for the development environment, on the other hand, may be small and stored in a low cost datastore to reduce the cost of application development. The dataset for the test environment may include data that might arise in rare operating scenarios that is not, at the time of testing the application, in the live dataset to ensure robust testing and full code coverage. Enabling an application to operate in any of multiple environments enables efficient movement between environments, such as development, test and production, and may enhance the efficiency of application development and overall operation of the IT system.

The dataset catalog 107 maintains mappings between logical datasets and one or more physical datasets associated with each logical dataset. Each record associated with a physical dataset may include context information associated with that physical dataset. Continuing with the example above, application 106-3 may be programmed with a logical dataset that is mapped to three different physical datasets in the dataset catalog. A record for each physical dataset in the dataset catalog includes context information identifying the environment in which the physical dataset is used—a first record includes context information indicating use in a development environment, a second record includes context information indicating use in a test environment, and a third record includes context information indicating use in a production environment. Upon execution of an operation within application 106-3 specifying access to the logical dataset, the dataset resolver 210 (i) identifies a current context associated with the operation (e.g., the environment application 106-3 is executing in, such as a development environment), and (ii) automatically selects one of the three records in the dataset catalog whose context information corresponds to the identified current context associated with the operation. For example, the dataset resolver 210 may select the record including context information indicating use in the development environment. It will be appreciated that identification of a different current context associated with the operation (e.g., execution in a production environment) may cause the dataset resolver 210 to select a different record in the dataset catalog (e.g., a record including context information indicating use in the production environment).

Representative Techniques for Developing an Application with a Dataset Multiplexer

In some embodiments, an application executed by a data processing system may be written in a graphical programming language by a human user of the data processing system. In other embodiments, a procedural language or other type of programming language may alternatively or additionally be used.

FIG. 3A illustrates a graphical user interface through which a data analyst or other human user may write an application in a graphical development environment and is used herein as an example of application development. In this example, the data processing system includes a library of components that perform operations on data. Though not expressly shown in FIG. 3A for simplicity, a graphical development environment may include a toolbar or other user interface element through which a user may select components from that library. The user may also specify connections between these components to form the graph. For example, components may specify operations to transform data or may specify a data source or a data sink that is to be accessed. Components may be represented by icons that have different shapes depending on the operation that is performed by the component or the type of data store holding the data for the data source or data sink.

The user may write an application by selecting components corresponding to desired operations and connecting them together in an order that specifies a desired data flow through the operations represented by the components. Each of the components may be configured through user input of parameters. Values of some configuration parameters may specify aspects of the operation of the component. A component representing a dataset, for example, may be receive a parameter that specifies operation as a data source or data sink.

In embodiments in which the application is written using logical datasets, values of some configuration parameters may specify a specific logical dataset and/or logical entities in the logical dataset for use in performing an operation of the component. For example, a component representing a dataset may be configured to represent a designated logical dataset by supplying as the value of that parameter an identifier of the logical dataset. A component alternatively or additionally may be configured with user input specifying a logical entity to be used as a key in a particular operation.

A data processing system may include a repository of information about logical datasets and/or logical entities that are available for use in configuring components of an application. Entries in this repository may have been created by the user writing the application. However, in an enterprise there may be many individuals involved in generating and analyzing data such that the information in the repository may not have been developed by the user developing the application. The logical dataset information, for example, may have been created by other users or even by automated analysis of certain physical datasets.

A user interface provided in the development environment may include user interface elements enabling a user to designate logical datasets or logical entities in the repository as the values of parameters that configure components of a graph. Those user interface elements may include elements for the user to input a search query. The query may, for example, be a faceted query in which the user specifies one or more values of dimensions that describe the logical datasets or logical entities. Those dimensions, for example, may include words entered in the repository to describe the logical dataset or the names of fields included within the dataset.

The data processing system may execute the search according to the query and return a list of options selected by the data processing system based on the query. The user may then select a returned value to configure a component, and the component will thereafter operate per the selection. For example, when a dataset component is configured as a data source configured to output data from a logical dataset, that component will operate, when the application is executed, by supplying in the format of the specified logical dataset.

It is not a requirement that an application be developed fully by a human programmer. All or portions of a program may be generated in other ways, such as from a template or converted by machine from another programming language or pseudo language. Regardless of the manner in which the application is developed, specifying data on which the application will operate in terms of one or more logical datasets enables the application to be written without any knowledge of or dependency on the physical storage of data. This capability can simplify any portions of the development process performed by a human user, as the human user can specify operations involving access to data in terms of the logical dataset and/or logical entities in the logical dataset. A data analyst, for example, may be able to write the application without understanding the details of any particular physical dataset. Further, avoiding dependency on physical storage in the application can expand functionality of the data processing system. The application can be written, for example, even if the details of the physical dataset that will exist at the time the application is executed are not known to the programmer or have not yet been established.

As a further simplification, a data processing system may be configured to perform operations specified in terms of logical datasets or logical entities within a logical dataset. These operations may be specified to be performed within an application and might then be performed on data accessed in a physical dataset corresponding to the logical dataset and specified for use in a context matching the context in which the operation is to be performed.

For example, a logical entity may be associated with an enterprise-wide list of valid values, and changes might be made to the list at the enterprise level, without need to change each and every application that accesses that logical entity. As a specific example, a logical entity for gender may be defined within a data processing system. At one time, metadata associated with that logical entity may indicate that allowed values are M and F. At a later time, the allowed values may change to be M, F, and X. Every application written in terms of that logical entity may automatically adapt to the changed list regardless of which physical dataset stores gender information. This is advantageous because indicating the “X” value as a newly allowed value in the metadata, for example, may automatically affect all applications that use the logical entity for gender.

As another example, validation rules may be specified in terms of logical entities and applied regardless of the physical dataset from which data is accessed. As a specific example, a data processing system may be configured with a data validation rule for a logical element used for e-mail addresses. That data validation rule may be applied to data from any physical dataset storing e-mails, once one or more fields in that physical dataset are identified as corresponding to the logical element used for e-mail addresses. The validation rules may be used within an application in one or more ways. For example, the rules may be invoked on data from a specific physical dataset from within the application or the application may access results of application of those rules to a particular physical dataset, even if application of the rules to the dataset were triggered from outside the application.

As yet another example, a component that performs a mask or a filter operation may be specified in terms of logical entities and/or metadata about logical entities and can operate within an application regardless of the physical datastore from which data being processed is pulled. As a specific example, logical entities that act as identifiers of people may be assigned privacy levels. Logical entities may be defined for multiple identifiers of people, such as e-mail address and social security number. Metadata associated with these logical entities may assign a moderate privacy level to an e-mail, but a social security number may be given a high privacy level. A filter or mask component specified in terms of logical entities can be configured to omit from its output records with certain field values associated with a privacy level above a threshold or obscure the values of those fields. When these operations are performed on physical datasets with fields corresponding to e-mail or social security number, they may be performed based on privacy level. Definition of logical datasets and associated metadata, such as privacy level, in a repository that may be used in developing applications enables functions such as these to be efficiently implemented and updated across an enterprise. Such definitions may also be used to enforce enterprise policies relating to data access by ensuring that physical datasets with sensitive information (i.e., datasets including fields containing sensitive information) are handled appropriately.

FIG. 3A illustrates an application (e.g., application 106-3) being developed as a dataflow graph via a user interface in a development environment. Here, the components are represented as nodes in the graph. The dataflow graph in this example includes an input node 302, 304 for each of the physical datasets from which data is read and an output node 316 for each of the physical datasets to which data is written. An example of generating such input and output nodes based on functionality they will provide (e.g., data sink or data source functionality) is described in U.S. Pat. No. 9,977,659, titled “Managing Data Set Objects,” which is incorporated by reference herein in its entirety. The dataflow graph also includes nodes 306, 308, 310, 312, 314 for various data processing operations (e.g., filter, sort, join, or compute operations) that are performed on the data read from the physical datasets. When the graph is executed by the data processing system, the results of the data processing operations are written to the physical dataset associated with the output node 316.

Each of the input nodes may be configured with parameter values associated with a respective data source. These values may indicate how to access data from the data source. Similarly, each of the output nodes may be configured with parameter values associated with a respective data sink. These values may indicate how to write the results to the data sink. In some examples, these parameters may map to context parameters that are provided to the dataset resolver 210 such that the values of these parameters form a portion of the current context used to select a physical data set corresponding to a logical dataset.

Conventionally, applications, including those written as dataflow graphs as shown in FIG. 3A, would need to be changed to account for changes in context associated with physical datasets. For example, if a particular physical dataset were associated with a logical dataset in one context, but the context changed, reprogramming of an aspect of the data processing system was required. An experienced developer for example, might manually change the configuration of an input node and/or output node of the dataflow graph impacted by the change. Such manual updates would need to be performed by the experienced developer possessing knowledge (e.g., programming knowledge) about the dataflow graphs and the data stores supported by a data processing system. In a data processing system that supports a large number of datasets where context changes occur frequently, either introducing an error during updating or neglecting to update programming for each change causes errors to propagate through the enterprise. For example, updating the programming of an input node of a dataflow graph to use an incorrect physical dataset in a particular context (e.g., in a production environment) might result in downstream operations to be applied to incorrect data, thereby resulting in inaccurate outputs.

The inventors have developed techniques for avoiding these problems by automatically providing access to appropriate physical datasets without needing to maintain an application/dataflow graph to accommodate for changes in context that might dictate a change in the physical dataset selected for association with a logical dataset. By enabling the data processing system to adapt to changes in context, (i) the risk for errors introduced in modifying, or failing to modify, applications is significantly reduced, thereby eliminating the propagation of errors common in the conventional systems, and/or (ii) users without expert knowledge about the physical datasets can perform various tasks throughout the lifecycle of the application and use the correct physical dataset at each step.

Such access may be enabled by a dataset multiplexer 105 that automatically provides connections between an application and appropriate physical datasets based on context. An application may be programmed in terms of logical dataset(s). For example, a business user possessing minimal knowledge about physical datasets (e.g., their location or formats) may write the application in terms of the logical dataset(s). The dataset multiplexer 105 may maintain a catalog of datasets, where a single entry or multiple entries in the catalog is/are associated with a logical dataset and provide information for accessing physical dataset(s) corresponding to the logical dataset in whatever data store it is stored at the time the application is executed. The information includes context information that enables selection of appropriate physical datasets for different contexts.

In some embodiments, the catalog may include multiple entries for one logical dataset, where each entry includes a record providing information for accessing a physical dataset used in a particular context. In some embodiments, the catalog may include one entry for a logical dataset, where the entry provides information for accessing multiple physical datasets corresponding to the logical dataset and used in different contexts. Regardless of the specific format of data stored in the dataset catalog, the stored information may provide for each of multiple logical datasets to be associated with multiple physical datasets and may define the context in which each of the multiple physical datasets is to be associated with the logical dataset.

In response to an indication that dataflow graph execution involves an operation on the logical dataset, the dataset multiplexer 105 may use current context information to select one of the multiple physical datasets associated with a logical dataset and then obtain the information for accessing the physical dataset from the catalog entry/entries associated with the logical dataset and automatically provide a connection between the dataflow graph and the physical dataset based on the information. In some embodiments, the information for accessing the physical dataset may include a program providing access to the physical dataset. The program, when executed by the application, may access the physical dataset from a data store and convert it to a format of the logical dataset. In some embodiments, a dataset resolver 210 may select the appropriate physical dataset based on the context of the operation and the context information stored in the dataset catalog. The dataset multiplexer 105 may then obtain the information for accessing the selected physical dataset from the dataset catalog.

FIG. 3B illustrates schematically how input node 302 of FIG. 3A is configured or programmed in terms a logical dataset. The input node 302 may be configured to represent a particular logical dataset that is specified via user input provided through the user interface. For example, user input may be provided via user interface 315. A listing 370 of logical datasets available for use in configuring the input and output nodes of the dataflow graph may be provided in the user interface 315. The logical datasets available for use in configuring the input and output nodes may be logical datasets for which entries exist in the catalog of datasets. The user may browse through the listing and select a particular logical dataset for configuring the input node 302. The user may input a search query via user interface element 372 where the user may specify one or more values of dimensions that describe the logical datasets or logical entities. Those dimensions may include words entered in the repository to describe the logical dataset or fields included within the logical dataset. FIG. 3B depicts that a “loyalty” logical dataset 375 is selected by the user and the input node 302 is configured to represent this selected logical dataset.

U.S. published application 2022/0245176 titled “Data Processing System with Manipulation of Logical Dataset Groups,” assigned Attorney Docket No. A1041.70070US02, describes various search interfaces through which a user may search for a dataset and/or a group of datasets as a target of an operation. The interfaces and techniques described in this application may be used in a data processing system described herein for purposes of configuring components of an application.

The catalog of datasets may include an entry for this selected logical dataset that provides information for accessing physical dataset(s) corresponding to the selected logical dataset. The information may be or include a program for accessing the physical dataset. When execution of the application involves an operation on the selected logical dataset, the dataset multiplexer may utilize the appropriate data catalog information to provide access to one of the physical datasets mapped to the logical dataset. For example, an identifier associated with the selected logical dataset may be used to identify a record associated with the appropriate physical dataset in the catalog of datasets including the program and the program may be executed to access the physical dataset from a data store. The dataset multiplexer may expose a link to the program such that access to the physical dataset is achieved by execution of the program at that link.

FIG. 3C illustrates schematically how such a connection may be made using the catalog of datasets in a development environment. This figure schematically illustrates application 106-3 as described above in connection with FIG. 3B. As shown in FIG. 3C, when the program is executed (which might occur in a development environment to determine whether modifications to the program are required for it to execute as intended), the input nodes 302, 304 and output node 316 of FIG. 3B are replaced with programs that provide access to the physical datasets corresponding to the logical datasets for which those components were configured. In this example, the programs provide access to physical datasets that are registered for use in the development environment. For example, input nodes 302, 304 are replaced with programs 330, 340 that provide access to each of the physical datasets in the data stores in which they are currently stored. Also, output node 316 may be replaced with program 350 indicative of a program that provides access to each of the physical datasets to which data is written, in the data store in which it currently resides. These programs may also make conversions between the format of the logical datasets with which the application is programmed and the format of the storage of the appropriate physical dataset in the data store.

FIG. 3D illustrates schematically how such a connection may be made using the catalog of datasets in a production environment. FIG. 3D shows the same application 106-3 of FIG. 3C executing in a production environment. As shown in FIG. 3D, components programmed with the same logical datasets can be replaced with different programs that provide access to different physical datasets that are registered for use in the production environment. In this example, the change between FIGS. 3C and 3D may occur automatically and/or without express user input because the environment in which the program is being executed may be a system variable that may be supplied to the dataset resolver 210 in connection with a request to determine the physical dataset associated with a logical dataset in the current context.

### Representative Dataset Catalog

The catalog of datasets 107 may include multiple objects, where each object stores information associated with a logical dataset. In this context, an object refers to the collection of information stored in computer readable medium that captures information related to a logical dataset. That information may be stored in any suitable format. For example, that information may be stored in a block of contiguous computer memory, distributed across multiple locations in computer memory, stored in a single file or other data structure, distributed across multiple data structures, or otherwise stored in a way that enables information reflected in the object to be related to a logical dataset. As noted above, information about a logical dataset may include or be linked to multiple records relating to physical datasets. That information may be stored as one entry in the catalog for the logical dataset with links to information about multiple physical datasets, or that information may be stored as multiple entries in the dataset catalog with each entry including information about the logical dataset and a physical dataset. Regardless of how the information is partitioned, for simplicity of explanation, the collection of information relating to a logical dataset and its associated physical datasets may be referred to as a single object for the logical data set.

The object may be related to the logical dataset in any suitable way. An object may have a predefined format including information, which may be formatted as a header, that identifies the logical dataset and/or the physical dataset to which the information relates. However, that information may be formatted other than in a header. The catalog, for example, may store a list of pointers to objects, indexed by logical dataset identifiers, such that accessing a pointer with a particular logical dataset identifier as an index enables a computer accessing the catalog to find the object associated with that logical dataset as the target of the pointer. Alternatively or additionally, some or all of the catalog information about a logical dataset may be stored as an addendum to a repository of information that may otherwise exist within the data processing system. For example, a data processing system may include a repository of metadata related to logical and/or physical datasets. Catalog information may be appended to this repository and/or stored in a separate metadata repository.

Information about a logical dataset may be reflected in an object in any suitable form. For example, information may be stored as one or multiple descriptors, each having a value. Alternatively or additionally, information may be stored as or include computer executable instructions. In some embodiments, each of the physical datasets mapped to the logical dataset may be reflected in the object because a program stored with the object in order to access each physical dataset is hard coded to access that physical dataset. In other embodiments, information identifying each physical dataset corresponding to a logical dataset may be stored as a value of a field in a data structure storing an object. That value may be passed as a runtime parameter to a program stored with the object in order to access the physical dataset(s) or otherwise used to access the physical dataset(s).

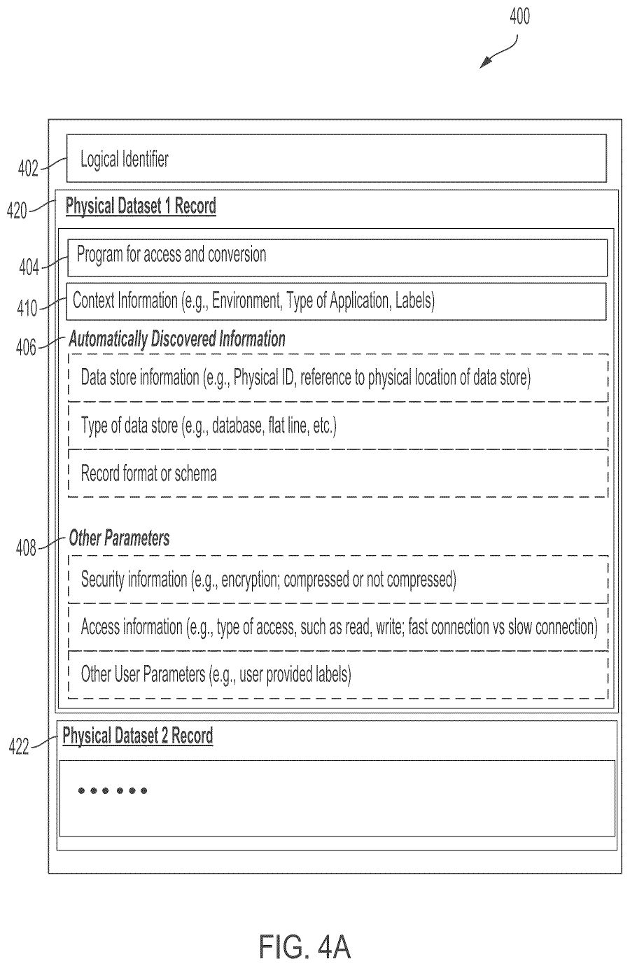

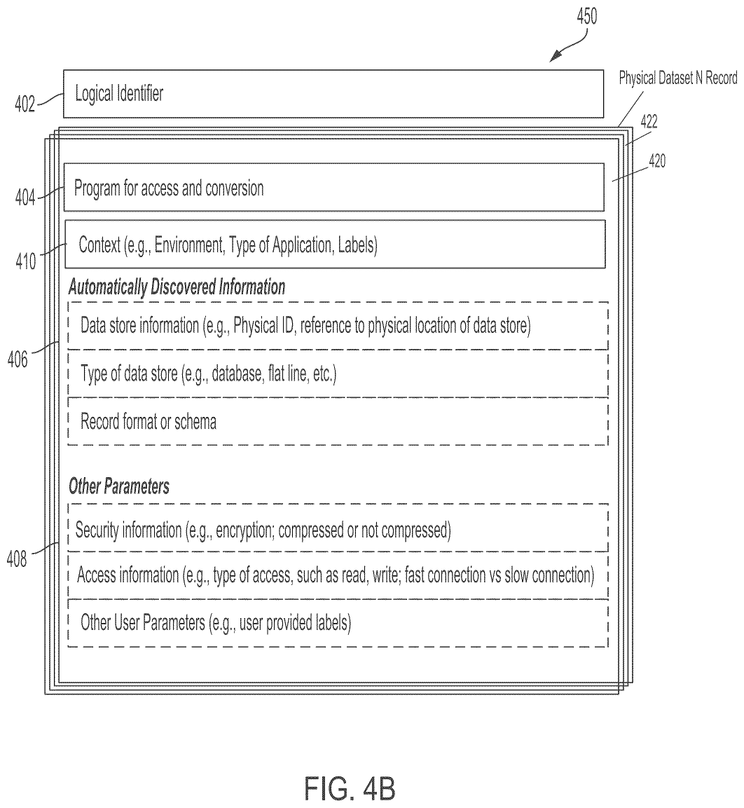

FIG. 4A illustrates an example object 400 in a catalog of datasets 107 maintained by the dataset multiplexer 105. In this example, the dataset catalog 107 includes one entry per logical dataset. FIG. 4A shows various pieces of information captured in object 400, however, some of that information, such as discovered information 406 and/or other parameters 408, may be optional.

Information captured in an object 400 may include information for identifying physical dataset(s) corresponding to a logical dataset. In this example, the object is identified by an identifier 402 of the logical dataset. The object 400 may include multiple records (e.g., records 420, 422 shown in FIG. 4A), where each record is associated with a physical dataset mapped to the logical dataset.

According to some aspects, each record associated with a physical dataset may include context information 410 associated with that physical dataset. Context information 410 may include multiple types of information. The context information, for example, may include information identifying a phase of a system development life cycle, such as by indicating an environment in which the physical dataset is used. The information identifying the environment may indicate one of a development environment, a test environment or a production environment. As another example, the context information may include information identifying a type of a data processing application that accesses the physical dataset. The information identifying the type of the data processing application indicates one of a batch application or a continuous application. As yet another example, the context information may include one or more labels. Each of the one or more labels, for example, may be a text string that indicates a size of the physical dataset, origin information of the physical dataset, or one or more other characteristics of data in the physical dataset. As a further example, the context information may include information identifying one or more users. The information identifying one or more users may indicate a role of users or permissions provided to the users dictating access to data or portions of the data in the physical dataset, and/or other information.

In some embodiments, information associated with a physical dataset may be conditionally stored in the dataset catalog during a registration process of the physical dataset. The context information (and possibly other information) for a physical dataset may be received through a user interface such that it can be stored in a record in the dataset catalog with the context information associated with the physical dataset. A check may be performed during the registration process to ensure that multiple records with same context information are not stored in the dataset catalog associated with the same logical dataset. For example, a determination may be made regarding whether the dataset catalog contains an entry associated with the logical dataset having the same context information as received through the user interface. The information about a physical dataset may be stored when the dataset catalog does not include an entry with the same context information for the same logical dataset. When the dataset catalog does contain an entry with the same context information for the same logical dataset, an error may be indicated through the user interface or other warning may be output.

The information reflected in object 400 may be or may include an executable program for accessing each physical dataset associated with the logical dataset. For example, record 420 associated with physical dataset 1 may include an executable program 404 for accessing physical dataset 1. When executed, the program may access the physical dataset 1 corresponding to the logical dataset and convert data in the physical dataset 1 to a format of the logical dataset or vice versa. The program may be reflected in a catalog object by storing a copy of the computer-executable instructions of the program in computer memory allocated for that object. In other embodiments, the program may be stored elsewhere, with only a pointer to or other identifier of the program stored in the computer memory allocated for the object. Similarly, although not shown, record 422 associated with physical dataset 2 may include the same types of information as in record 420, including an executable program for accessing that physical dataset.

In some embodiments, the program 404 may be created using discovered information 406 identified during a registration process of the physical dataset and/or parameters 408 otherwise used to access the physical dataset.

The object may reflect information about the physical data source storing each physical dataset that enables access to and conversion of data in the physical dataset. That information may be obtained in any of a number of ways, including via user input or via an automated discovery process performed by reading data or metadata from the data source storing the physical dataset. In some embodiments, discovered information 406 may be automatically discovered as part of a registration process of the physical dataset with the dataset multiplexer 105. As part of the registration process, a user may specify a logical dataset to which a physical dataset corresponds, or the correspondence between a logical and physical dataset may be determined in another suitable way. The automatically discovered information may include a physical identifier associated with the data store and/or physical dataset, a reference to a storage location of the data store and/or physical dataset, a type of data store, a record format or schema of the physical dataset, and/or other information.

In some embodiments, a copy of this discovered information may be stored in the object. In other embodiments, the discovered information 406 may be reflected in the object because it is used to create the program to access the physical dataset, which is stored as part of the object. For example, a type and format information of the data store and/or physical dataset may be used to create the program with conversion logic to convert the data in the physical dataset to a format of the logical dataset.

Parameters 408 may specify a manner in which to access the physical dataset and/or data store. In some embodiments, these parameters may be design-time and/or may be run-time parameters. Design-time parameters may be applied to specify functions of program 404. If the program is generated based on the design-time parameters, values of those parameters need not be separately stored in object 400. If runtime parameters, their values may be stored in the object and supplied as inputs to the program when executed. Alternatively or additionally, identifiers for the runtime parameters may be stored and values of the identified parameters may be determined at runtime, such as by reading a memory location allocated to storing the value of the parameter.

Parameters 408 may include one or more parameters specifying a type of access to a physical dataset. In some embodiments, the type of access may indicate the amount of bandwidth allocated for access of a particular logical dataset. For example, a value of a parameter 408 may indicate dedicated access or shared access. A data store may support a number of connections to applications 106 that can use in the aggregate no more than a predetermined amount of bandwidth accessing a data store. An allocation approach may be applied to enable applications that perform higher priority tasks than others to use more of the total available bandwidth for the data source. As a specific example, the data source may support dedicated access and shared access, with dedicated access for an application resulting in more of the available bandwidth allocated to an application than when shared access is provided. Specifying dedicated access to the logical datasets used by higher priority applications and shared access to the logical datasets used by lower priority applications may allocate available bandwidth at a data source as desired.

As another example, an access parameter alternatively or additionally may indicate a type of connection used to access the data store holding the physical dataset corresponding to the logical dataset, such as fast connection or a slow connection.

As yet a further example, parameters 408 may include one or more parameters specifying compression-related and/or security-related information. In some embodiments, the one or more parameters may indicate whether the data in the physical dataset is encrypted. In embodiments in which the data is encrypted, the parameters 408 may include information such as a security key to decrypt that information, or otherwise make it usable. To enhance security, the security key may be provided by applications 106 at runtime and may not be stored in the catalog of datasets 107. In some embodiments, the one or more parameters may indicate whether data in the physical dataset is masked. In other embodiments, the one or more parameters may indicate whether the data in the physical dataset is compressed. In embodiments in which parameters 408 are used to create program 404, a value of a parameter 408 indicating that the data in the physical dataset is encrypted may be used to include decryption logic in the program.

As a further example, parameters 408 may include one or more parameters specifying criteria for a filter operation. For example, the one or more parameters may specify a date that may be used to filter information when accessing the physical dataset. As another example, the one or more parameters may specify a limit on the number of records of the physical dataset to be accessed. As yet another example, the type of access may indicate a read access or a write access.

In some embodiments, some or all of the values of parameters 408 may be automatically discovered. This automatic discovery process may be performed when a physical dataset is registered with a component of the data processing system that creates a dataset catalog. During the discovery process, for example, a component of the data processing system may access metadata in a data store to determine information reflected in the object. Alternatively or additionally, a component of the data processing system may analyze data read from a physical dataset to recognize patterns in the data that indicate a record format, encryption, compression or other information about the physical datastore.

However, it should be appreciated that the discovered information 406 could be obtained other than with direct interaction with a data source, such as by reading from a repository of metadata relating to logical and/or physical datasets maintained by the data processing system. For example, security information, such as encryption or compression, may be applicable to all datasets within a data store. Once security information is stored anywhere in the system for one physical dataset in a data store, that security information may be reflected in objects used in accessing other physical datasets in the same data store.

Some or all of the information reflected in an object, even if indicated in the example of FIG. 4A as being discovered, may be input by a user. In other embodiments, some portion of the discovered information 406 and/or parameters 408 may be specified by a user via the user interface as part of the registration process. However, it should be appreciated that user input may be supplied in other ways, such as when defining a logical dataset. As a specific example, priority of a logical dataset may be specified either when the logical dataset is defined or, after it is defined, by editing the metadata stored for that logical dataset.

Moreover, it should be appreciated that FIG. 4A shows an object, configured for access to multiple physical datasets, associated with a logical dataset at one moment in time. The data processing system may detect events that impact storage of data associated with a logical dataset. If so, the object for that logical dataset may be updated. For example, values of any of the parameters may be updated whenever a change to the values of those parameters is detected. Alternatively or additionally, if a new physical dataset is registered, with input indicating that it is storing data for a logical dataset for which an object already exists in the catalog, the object for the logical dataset may be changed to add a new record associated with the new physical dataset for use in a different context. A change may be implemented, for example, by wholly or partially overwriting the object with new information or replacing it with a new object to reflect the new physical dataset. The object for the logical dataset, however, may be accessed in the same way via the dataset catalog. In this way, once an application, written to perform data access operations based on a logical dataset, is configured to access a physical dataset corresponding the logical dataset via the dataset catalog, it will continue to correctly access the correct physical dataset despite any changes.

In some embodiments, program 404 may be configured as an executable dataflow graph that includes the logic for accessing a physical dataset. In embodiments in which applications are developed as graphs, as described above in connection with FIGS. 3A-3D, program 404 may be configured as a subgraph in the sense that it will be executed as part of a dataflow graph implementing an application. For example, FIG. 3C depicts a first program 330 configured as a subgraph that includes logic for accessing an input dataset, a second program 340 configured as a subgraph that includes logic for accessing an input dataset, and a third program 350 configured as a subgraph that includes logic for accessing an output dataset.

These subgraphs may be considered to be dynamic subgraphs (DSG) because the subgraphs are updated from time to time based on events that indicate changes to the appropriate mechanism for data access for the storage associated with a logical dataset. The subgraphs may also be regarded as dynamic when executed within a data processing system that executes data access operations in graphs (or programs in other forms) based on the storage environment in which the accessed data is stored. For example, a data processing system may execute the logic encoded in a subgraph differently for access to a data store in on-premises storage versus the same data store in cloud storage. Accordingly, when a physical dataset is migrated from a first data store to a second data store, the subgraph in a catalog entry may be executed by the data processing system to implement the appropriate access methods for the storage environment of the physical dataset at the time regardless of where it is stored. Therefore, use of the subgraph data access operations within the application, results in dynamically accessing the physical dataset that stores the correct data at that time. Accordingly, a DSG is used herein as an example of a program 404.

FIG. 4B illustrates an example in which the object 450 for a logical dataset in dataset catalog 107 includes multiple records for a logical dataset, where each record is associated with a physical dataset linked to the logical dataset. The information maintained by the data multiplexer 105 for each of the records is the same that described with reference to FIG. 4B and is not repeated here.

In some embodiments, each record in the dataset catalog 107 comprises a plurality of fields representing the context information associated with the physical dataset. At least some of the plurality of fields may be configured to store a value of a set of enumerated values. The plurality of fields comprises a first field configured to store a value from an enumerated set of values indicating a type of application (e.g., batch or continuous), a second field configured to store a value from an enumerated set of values indicating an environment of the data processing system (e.g., development, text, or production), and a third field configured to store a label (e.g., a text string indicating a size or origin information of the physical dataset).

Representative Dataset Multiplexer with a Dataset Catalog

FIG. 5A is a block diagram 500 highlighting components of dataset multiplexer 105 of data processing system 104. As shown in FIG. 5A, dataset multiplexer 105 includes, among other components, registration module 520, dynamic subgraph (DSG) generator 524, metadata management module 526, operational metadata module 528, catalog services interface 522, and user interface 530.

In some embodiments, registration module 520 is configured to register physical datasets with the dataset multiplexer 105. Registration may be triggered by addition of physical datasets to an IT infrastructure or by use of the physical dataset from an application. Alternatively or additionally, registration module 520 may receive a command to register a physical dataset via user interface 530. For example, a user may provide input via user interface 530 to initiate the registration process of the physical dataset. That input may be in the form of a direct command to register a physical dataset. In some aspects, context information associated with the physical dataset may be received through the user interface 530.

Alternatively or additionally, that input may indirectly indicate that registration is to be initiated. For example, registration may be triggered when a user writing an application selects a logical dataset that has been associated with a physical dataset for which there is no information in the dataset catalog or for which information in the catalog is not up to date. Other actions, serving as indirect commands, may include an indication to migrate a physical dataset from one data store to another or a command to change the metadata associated with a logical dataset that might impact the conversion between a physical dataset and the logical dataset. Regardless of how the registration process is triggered, user input may specify a logical dataset corresponding to the physical dataset such that an object/objects in the catalog for the logical dataset may be created or overwritten with up to date information.

Other information to create or update object(s) in a catalog may be gathered from one or more sources. Registration module 520 may discover information regarding the physical dataset and/or the data store in which it is stored during the registration process. Information gathered in this way may include the type of data store, record format or schema of the physical dataset, physical storage location of the data store, compression and/or encryption status, and/or other information.

In some embodiments, the registration module 520 may create multiple records in the dataset catalog 104 using the information received, discovered, or otherwise gathered during the registration process. Each record may be associated with a physical dataset and multiple records may be associated with a logical dataset. As noted above, registration module 520 may, prior to associating a record for a physical dataset with a logical dataset, check that the context associated with that physical dataset is unique with respect to the context provided for other physical datasets already associated with the logical dataset. The registration module 520 may, upon detection that the context information is not unique, generate an error message to a user performing the registration or take other corrective action.

Registration module 520 may provide the obtained information to DSG generator 524. DSG generator 524 may create a DSG based on the received information. DSG generator 524, for example, may have access to a number of program templates, each program template corresponding to a particular type of data store. DSG generator 524 may detect a type of data store from the received information and select, from among the number of program templates, an appropriate program template corresponding to the detected type. For example, the data processing system may be pre-configured with templates for read and/or write access to data tables in an ORACLE database or in an HADOOP distributed database. Detecting the type of data store storing a physical dataset may enable DSG generator 524 to select an appropriate template for access to the physical dataset corresponding to the logical dataset for which the DSG is being created.

DSG generator 524 may generate a program based on the selected program template. DSG generator 524 may detect values for parameters of the selected program template from the received information and may populate the program template with the detected values. Some or all of the values of parameters may alternatively or additionally be obtained from metadata management module 526, which in this example may maintain metadata for the physical datasets, data stores and/or logical datasets. Parameters may alternatively or additionally be supplied via user input using the user interface 530 or obtained in other ways.

DSG generator 524 generates a DSG that includes access logic for accessing a physical dataset and conversion logic for converting between a format of the physical dataset and a format of the corresponding logical dataset. DSG generator 524 may generate a logical layer to physical layer mapping for the physical dataset and the corresponding logical dataset. DSG generator 524 may generate a mapping between one or more fields of a logical dataset and one or more fields of a physical dataset that represent the same information. This mapping may be generated with information from various sources, including information available within the data processing system, user input and/or information derived through semantic discovery. DSG generator 524 may utilize the mapping to generate the conversion logic. For example, a customer name in the physical dataset may be stored as three fields in a row of a data table, holding data corresponding to the customer's first name, middle initial and last name, respectively. The logical dataset, however, may simply include a logical entity Customer_Name. DSG generator 524 may generate a mapping between these three fields of the physical dataset and the logical entity of the logical dataset. The conversion logic may include logic that converts between the “customer's first name, middle initial and last name” format of the physical dataset to the “Customer_Name” format of the logical entity. When the DSG is executed, the access logic is executed to obtain information from the three fields of the physical dataset and the conversion logic is executed to convert between formats of the physical dataset and the logical dataset.

In some embodiments, DSG generator 524 creates a DSG for each of multiple physical datasets in a data store. The created DSGs may be included in the catalog of datasets 107. The catalog of datasets 107 may include objects associated with logical datasets, where each object may be or include a DSG for accessing a physical dataset corresponding to the logical dataset.

Alternatively or additionally, DSG generator 524 may receive one or more custom subgraphs for one or more physical datasets from a user of the data processing system. The custom DSGs may include customized access logic and conversion logic. The custom DSGs may be included in the catalog of datasets 107, where each custom DSG may be used for accessing a corresponding physical dataset.

Registration module 520 also may provide discovered information to metadata management module 526 such that metadata management module 526 may receive and maintain metadata for the physical datasets and/or data stores. In some embodiments, metadata management module 526 may be a source of information for dynamic subgraph generator 524 when generating a DSG and may additionally store metadata about datasets, which may be used in other operations involving datasets within the data processing system. Metadata management module 526, for example, may maintain information, serving as metadata regarding a logical dataset, information about logical entities in the logical dataset, relationships among the logical entities of the dataset, and relationships with other logical datasets and/or entities of other logical datasets.

Metadata management module 526 also may store the mapping between the logical datasets and the physical datasets, which may be based on user input or, in some embodiments, derived such as by monitoring operations in which a user has directly or indirectly specified an association between a logical and a physical dataset as part of a data processing operation. Regardless of how acquired, in some embodiments, that mapping may provide a one to many mapping between some or all of the logical datasets and physical datasets. In some examples, such a mapping may be maintained by metadata management module 526 as a table or other data structure mapping an identifier of a logical dataset to an identifier of one or more physical datasets corresponding to the logical dataset. Context information as described above may be maintained in connection with the mapping, such that the appropriate physical dataset may be selected based on the mapping and the context at the time a dataset is to be accessed. This information, for example, may be used by dynamic subgraph generator 524 in creating object(s) representing a logical dataset and/or determining that storage of data associated with a logical dataset has changed. In some examples, this mapping may be updated based on detected events and/or user input.

Metadata management module 526 may maintain a listing of logical datasets known to or accessible by data processing system 104. When programming an application in terms of a logical dataset, the listing of known logical datasets may be presented to a user via a user interface of the application and the user may select a particular logical dataset from the presented listing. This logical information maintained by the metadata management module 526 may be used, for example, to enable a user to search for a specific logical dataset for use in writing an application. Information about physical datasets corresponding to respective logical datasets for a context applicable for the search, may also be used in searching for an appropriate dataset. That information may also be stored by metadata management module 526. For example, this logical and physical information may be used to define dimensions of a faceted search for a dataset.

A data processing system may maintain other types of metadata about datasets, which may also be available for a user searching for a dataset for a particular scenario. For example, metadata relating to use of datasets may be captured and stored when datasets are used. This operational metadata may also be used by a dataset search tool to enable a user to search for datasets based on their usage by others.

Operational metadata module 528 may collect operational metadata regarding the datasets. The operational metadata may be collected during or after execution of an application or other program that accesses a dataset. The operational metadata collected during execution may include identifying information regarding physical datasets accessed, the date and time of access, whether the dataset was updated, values of parameters associated with execution of one or more subgraphs that accessed the datasets, and/or other operational data, including, for example, information identifying the context in which the dataset was used. Operational metadata collected or determined after execution may include information regarding frequency of access of datasets, whether physical, information regarding recency of access, or information regarding the size of data accessed (e.g., number of records that were read from and/or written to). Some operational metadata may be user information, such as information regarding users that created or accessed the datasets (e.g., a name of the user that read data from or wrote data to the datasets). This user information may include a role of users in the enterprise, permissions provided to the users, and/or other information about people in an enterprise.

In the example of FIG. 5A, catalog services interface 522 integrates access to the various types of metadata about datasets. It may provide, for example, a faceted search tool that enables searching on any of a number of facets that may exist in any of the logical, physical and/or operational metadata that may be stored about physical and/or logical datasets that a user may wish to select when writing an application or otherwise specifying operations to be performed on a dataset. Facets in the search may be based on the information about the logical datasets, physical datasets, and/or operational metadata stored within the data processing system. For example, a search for a dataset may be qualified to return only datasets for which there is an entry/object in the dataset catalog. This facet may be combined with other facets relating to logical or physical datasets to provide a powerful search interface. For example, the search query can be qualified to return only datasets accessed within the past week and only those logical datasets with an e-mail field for which a corresponding physical dataset is stored in a data store with high speed access. In some embodiments, the facets may be configurable or user-defined.

Though FIG. 5A shows separate modules managing different types of metadata, it should be appreciated that this depiction is segregated by function and that the hardware and/or software components that capture and/or provide multiple types of metadata may be partitioned in other ways, including integrating the capture and management of all such metadata in a single module or in more modules than are illustrated.

Catalog services interface 522 also enables applications 106 to be programmed in terms of logical datasets. For example, an identification of the logical dataset selected by a user for programming an application along with some or all of the current context information (e.g., system context parameters may be omitted) may be passed through the catalog services interface 522. In return, catalog services interface 522 may provide information that enables applications written in terms of that logical dataset to access the appropriate physical dataset. Catalog services interface 522 may access catalog of datasets 107 that provides information for selecting and accessing an appropriate physical dataset corresponding to the logical dataset. A catalog object may be or include a program, in this example shown as a DSG, for accessing a physical dataset corresponding to the logical dataset.

Catalog services interface 522 may enable an application to access the physical dataset by providing information about the program in the object for the selected logical dataset in the catalog of datasets 107. Upon execution of an operation to access a logical dataset from within an application, the application may use that information to access the corresponding physical dataset in a data store. In this way, the program identified from the catalog object may be executed to access the physical dataset from the data store. For example, catalog services interface 522 may expose a link to the DSG, which a development environment in which the application is being developed can use to structure the application such that access to a physical dataset is achieved by execution of the DSG at that link at the time of execution of the application. In some embodiments, catalog services interface 522 provides this link via an Application Programming Interface (API).

One or more events may result in changes to the objects in the dataset catalog. For example, in response to an event indicating a change to a format of a physical dataset, the appropriate catalog object may be updated. For example, if the format of the physical dataset is changed by adding fields to the dataset, the corresponding catalog object may be updated to account for the added fields. In some embodiments, the conversion logic in a program for accessing the physical dataset may be modified to account for this change. As another example, in response to an event indicating a change to values of parameters used to generate the program or accessed in the program, the values of the parameters stored in the catalog object may be updated and/or the program may be re-generated with the new values. As yet another example, an event indicating a change associated with a physical dataset corresponding to a logical dataset may include an event indicating a replacement of the physical dataset with another physical dataset that corresponds to the same logical dataset. In this example, a catalog object corresponding to the first physical dataset may be replaced or substituted with a catalog object corresponding to the other physical dataset. These changes may be implemented by dynamic subgraph generator 524, which may be triggered to update the catalog object upon detection of an event. The update may be implemented, for example, by wholly or partially overwriting the memory locations storing the catalog object or by associating an object stored in other memory locations with the dataset catalog entry such that the catalog object for a particular catalog entry is updated when it is replaced by a new object. A trigger for such changes may be supplied by user input or may be automatically detected by dynamic subgraph generator 524, catalog services interface 522 or other component of the data processing system.

It will be appreciated that when an application written in terms of a logical dataset is executed and the dataset catalog 107 is accessed to provide the application with access to a physical dataset corresponding to the logical dataset, one or more components, such as registration module 520, dynamic subgraph generator 524, metadata management module 526, operational metadata module 528, and/or user interface 530, may be optional. Upon execution of an operation to access a logical dataset from within an application, the application may, based on the identifier associated with the logical dataset, obtain information about the DSG associated with the logical dataset from the dataset catalog 107 via the catalog services interface 522. In some embodiments, the catalog services interface 522 may provide this information to the application by exposing a link to the DSG. The DSG when executed provides the application with access to the physical dataset corresponding to the logical dataset.

It should be further appreciated that a dataset multiplexer need not be implemented such that a dataset catalog 107 is accessed every time an application is executed. In some examples, information from a dataset catalog for access to a physical dataset associated with a logical dataset at a particular time may be obtained from the dataset catalog and stored where it can be accessed when an application specifying access to that logical dataset is executed. The access information may be stored, for example, as part of a project. That pre-stored access information may be updated whenever changes occur, such as changes to the datasets associated with the project and/or the data catalog for the project. In some examples, the pre-stored physical dataset access information may be encoded as a dynamic subgraph, which may be regenerated in response to changes in the project that could impact access to the physical dataset.

In some examples, whether and how access information is prestored may differ depending on system context parameters and/or user input. For example, in a production environment, access information may be prestored and automatically updated, but in a development environment pre-storing and/or updating access information may be based on user input.

FIG. 5B is a block diagram highlighting an additional component of dataset multiplexer 105 of data processing system 104. As shown in FIG. 5B, the dataset multiplexer 105 includes a dataset resolver 210 that resolves a reference to a logical dataset that may be associated with multiple physical datasets to one or more of the physical datasets based on context information. When an operation within an application 106-2 written in terms of a logical dataset is executed, the dataset resolver 210 selects a record associated with a physical dataset from the dataset catalog 107 by evaluating a current context associated with the operation and the context information associated with the one or more physical datasets associated with the logical dataset. The context information associated with the physical datasets may be obtained from the records associated with the multiple physical datasets mapped to the logical dataset in the dataset catalog 107. In scenarios in which the access information has been prestored, as noted above, rather than accessing the dataset catalog 107 at that time, execution of an operation that accesses a logical dataset may apply information from the dataset catalog 107 by using prestored information (such as a dynamic subgraph) generated from information retrieved via the dataset catalog 107.

The dataset resolver 210 may identify a context associated with the operation. The context may be identified automatically based on system information, such as by identifying an environment (e.g., development, test or production) of the data processing system in which the application is executed or invoked or identifying a type of the application (e.g., batch or continuous). The dataset resolver 210 alternatively or additionally may identify a context based on user input, such as by prompting a user to provide input indicating a value of a parameter comprising a portion of the context (e.g., labels) associated with the operation.

As shown in FIG. 5B, the environment of the data processing system in which application 106-2 is invoked may be identified as a development environment. The dataset resolver 210 may select a first record from at least two records associated with the logical dataset in the dataset catalog 107 when the context information in the first record identifies the environment in which the physical dataset is used as the development environment. Information for accessing the physical dataset (e.g., DSG 250) is obtained from the selected record and invoked for accessing the physical dataset in datastore 102-n.

FIG. 5C shows a scenario in which the dataset resolver 210 uses context to select a physical dataset when the application is executed in the production environment. The dataset resolver 210 may select a second record from at least two records associated with the logical dataset in the dataset catalog 107 when the context information in the second record identifies the environment in which the physical dataset is used as the production environment. Information for accessing the physical dataset (e.g., DSG 260) is obtained from the selected record and invoked for accessing the physical dataset in datastore 102-1.

Therefore, the dataset resolver 210 enables selection of an appropriate physical dataset from among multiple physical datasets mapped to a logical dataset by utilizing context information stored in the dataset catalog 107 in comparison to current context information. Such selection enables seamless transition between different contexts without requiring changes to logical datasets or applications programmed with the logical datasets or even changes in the programming of the dataset catalog.

In some embodiments, the dataset resolver 210 may identify an ambiguity when both the first and second records are identified for selection. This may arise when the context information associated with both the first and second records correspond to the identified context associated with the operation. The ambiguity may be resolved by prompting user input through the user interface 530. For example, information identifying the physical datasets associated with the two records may be presented to the user to allow selection of one of the physical datasets. As another example, an option to update the context information in at least one of the records may be provided to the user. The user may update the context information in a record such that it is no longer corresponds to the identified context associated with the operation.

### Representative Application Configured for Data Access Via a Dataset Catalog Object

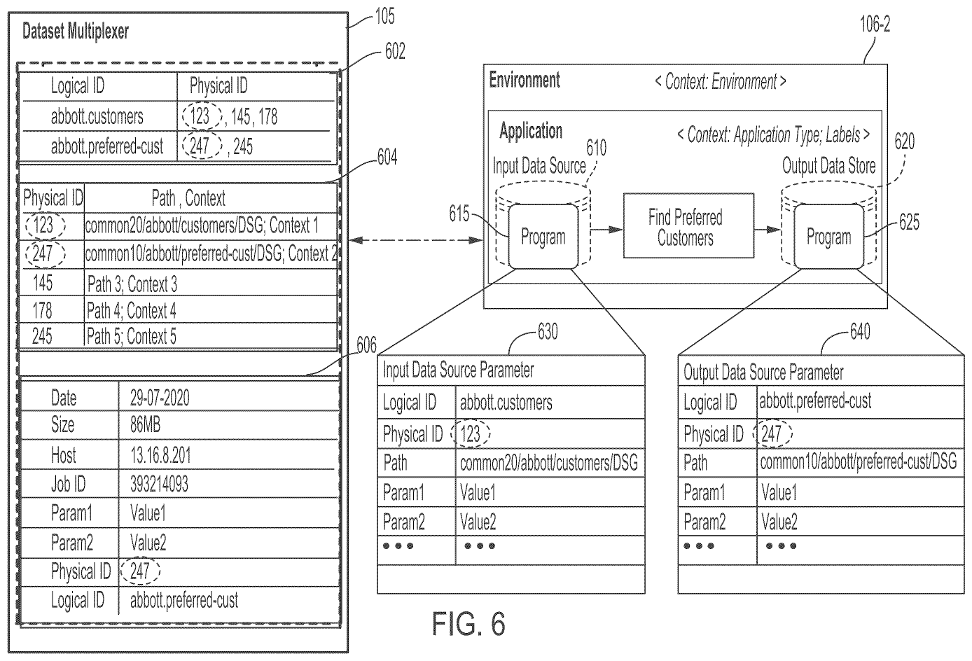

FIG. 6 is a block diagram illustrating various pieces of information maintained by a data processing system, including the dataset multiplexer 105. This information may enable application 106-2 to be configured to access a physical dataset based on a programmed logical dataset. Some of this information may be recorded as a result of execution of the application once it has been configured. This recorded information may provide operational metadata for other functions performed by the data processing system, including providing a search interface through which users may later search for datasets to use in applications based on prior operations on datasets.

In this example, application 106-2 has been written to read data from a dataset that contains information about customers. It then extracts records from that dataset representing preferred customers and writes the results to a second dataset. When executed, application 106-2 will read from and write to physical datasets. However, application 106-2 may be programmed in terms of a first logical dataset associated with an input data store 610 and a second logical dataset associated with an output data store 620.

As application 106-2 is being written, a user may provide configuration inputs for input datastore 610 that specify a logical dataset from which data is to be read. In this example, the logical dataset is identified as “abbott.customers.” That dataset may be selected by user input, such as selecting from a list of all logical datasets registered with the data processing system or selecting from a limited list returned in response to a user query for datasets with user specified parameters. Such a selection interface may be provided by the development environment for application 106-2.

Similarly, output datastore 620 may be configured with a logical dataset. In this example, the logical dataset has been identified as “abbott.preferred-cust.”

To enable the application to execute, the development environment may relate the selected logical datasets to information that enables read and write operations to be performed on the physical datasets corresponding to the specified logical datasets at the time the application is executed. This may be done, for example, by obtaining information through catalog services interface 522 (FIG. 5A). Catalog services interface 522 may provide, such as in response to a request for catalog information relating to a logical dataset, information about a program, associated with a record selected by the dataset resolver, which is maintained so that, when the program is executed, it accesses the physical dataset corresponding at that time to a particular logical dataset. In this example, information about the program is provided as a path within a directory structure to a file storing the program. In this example, the link to the program to access the physical dataset corresponding to input logical dataset “abbott.customers” is stored at the path “common20/abbott/customers/DSG.” However, a link to the program may be supplied in any suitable format.

Similarly, the program, associated with a record selected by the dataset resolver, for access to the physical dataset corresponding to the output logical dataset “abbott.preferred-cust” is obtained. In this example, that path is “common10/abbott/preferred-cust/DSG”. These links to programs that can access physical datasets may be exposed by the catalog services interface 522 during execution of the application. These links may be stored as part of the computer-executable representation of the application such that, upon execution of operations within the application that access these datasets, the programs can be executed. Alternatively, information sufficient to execute the programs to access the physical dataset may be obtained at any time prior to execution of an operation to access a data source, including at the time of execution of the application. Further, the approach for obtaining the information, (e.g. via catalog services interface 522 or from prestored information) may depend on system context information, such as whether the application is executed in a development or production environment.

Regardless of when, in relation to the execution of application, information about a program to provide access to a physical dataset is identified, dataset multiplexer 105 may provide information about that program. FIG. 6 illustrates that dataset multiplexer 105 maintains information sufficient to relate a logical dataset to program(s) to access physical dataset(s) corresponding to that logical dataset. This information may be stored as a dataset catalog object for the logical dataset, for example. In some embodiments, this information may be fetched or provided by the dataset multiplexer 105 at run-time and/or design/build time of the application with refresh when the information changes.

In the example of FIG. 6, the information is shown stored as two relationships. A physical identifier of the physical dataset is used as a key to tie information 602, 604, and 606 together. First information 602 provides information linking each logical dataset, by a logical ID used for that logical dataset to identifiers of the physical datasets currently storing the data corresponding to that logical dataset. Second information 604 provides a relationship between the physical dataset and a program that may be used to access it as well as the context information associated with it.

In the example of FIG. 6, first information 602 links logical dataset “abbott.customers” to a first physical dataset, identified by identifier “123”, a second physical dataset, identified by identifier “145”, and a third physical dataset, identified by identifier “178”. The program at path “common20/abbott/customers/DSG” is related to the physical dataset with identifier “123” via second information 604.

Likewise, logical dataset “abbott.preferred-cust” is related to physical dataset IDs “247” and “245” through first information 602. The program at path “common10/abbott/preferred-cust/DSG” is related to physical dataset 247 through second information 604.

Similar information may be maintained by dataset multiplexer, such as in dataset catalog objects, for each logical dataset for which corresponding physical dataset(s) have been registered. Alternatively or additionally, some or all of this information may be maintained by metadata management module 526 or other module within the data processing system. Regardless of how the information is maintained, dataset multiplexer 105 may provide information about a program to access any physical dataset corresponding to a logical data set.

In the example of FIG. 6, the identified program at path “common20/abbott/customers/DSG”, along with information used to invoke it, is stored as DSG 615 in the place of the specified input data store 610. DSG 615 may be referred to as a “read DSG” that reads data from the physical dataset corresponding to the input logical dataset “abbott.customers”. Likewise, the program at path “common10/abbott/preferred-cust/DSG”, along with information used to invoke it, is stored as DSG 625 in the place of the specified output data store 620. DSG 625 may be referred to as a “write DSG” that writes data to the physical dataset corresponding to the output logical dataset “abbott.preferred-cust”.

The information indicating a program to be executed within an application may be stored in conjunction with the program instructions that make up the application. In a scenario in which the application is written as a dataflow graph and the programs to access data sources are written as subgraphs, these subgraphs may be dynamically linked into the dataflow graph at appropriate locations in the dataflow graph for execution. The locations may correspond to the input and/or output nodes of the dataflow graph. During or just prior to execution of the dataflow graph, the link or path information for the subgraphs exposed by or obtained from the catalog services interface 522 may be provided to the input and/or output nodes and the corresponding subgraphs may be linked and/or stored in place of the input and/or output nodes. An example technique for dynamically linking subgraphs into a dataflow graph via a sub-graph interface as described in U.S. Pat. No. 10,180,821, entitled Managing Interfaces for Sub-Graphs, which is incorporated herein in its entirety, may be used. However, other methods of storing information to execute the program may alternatively or additionally be used.

When application 106-2 is executed and an operation to access a logical dataset associated with the input data store 610 is encountered, context associated with the operation may be identified by dataset resolver 210. Based on the identified context, a record in the dataset catalog including context information that corresponds to the identified context may be selected and DSG 615 associated with the selected record may be invoked. Invoking DSG 615 may result in its access logic and the conversion logic to be executed. Upon execution, the input data store 610 may be accessed and data from the input data store and/or a corresponding physical dataset of the input data store may be read and converted to a format of the logical dataset. Invoking a DSG may entail providing parameters to a controller module (not shown) within the data processing system.

In the example of FIG. 6, the parameters supplied for execution of DSG 615 are shown as parameters 630. In this example, one of the parameters 630 identify the DSG, such as by providing its path. The value of this parameter may be stored at the time the input data source 610 is configured for a specific logical dataset. In other examples, if the value of a parameter is unknown at the time of authoring the application, it may be specified at execution time or any time in between.

Others of the parameters 630 may be provided such that they can be supplied by the controller module to the DSG 615 for execution. These run-time parameters (i.e., supplied at run-time) may impact execution of the DSG. For example, values for parameters “Param1” and “Param2” may be supplied at run-time to the DSG. The value of one such parameter may specify, for example, that the DSG 615 should be executed in a specific read mode (single record, batch, quick, shared, etc.). Values of parameters may reflect an access priority for the application, as another example.

Values for these run-time parameters may be obtained in one or more ways. For example, they may be encoded in the application 106-2 based on input provided by a user at the time the application was developed. For example, values of parameters may be derived from information input as configuration parameters for input data source 610 in the development environment. As another example, values of parameters alternatively or additionally may be derived from other user inputs during development of the application or in response to prompts at the time of execution. As yet another example, the application may identify the values of parameters during run-time from various inputs, such as external inputs indicating a time of day, current system load, or other inputs that depend on the data provided as input to the dataflow graph.

As yet another example, values of parameters alternatively or additionally may be obtained from other modules. As a specific example, the values of at least some of the parameters 630 may be read from or obtained by processing information in a metadata repository storing information about the logical dataset associated with input data store 610. As yet another example, values of at least some of the parameters 630 may be read from or obtained by processing information in an access control module that maintains information about users, and may reflect an access priority or mechanism to a data store that is set based on the role of the user who developed the application or who is executing the application.

Values of other parameters in input data source parameter 630 may be included such that the controller module, or other component of the data processing system, may capture operational metadata. For example, the logical identifier of the dataset for which access is encoded may be stored for this reason, for example. Likewise, the identifier of the physical dataset being accessed may be stored. The value of this parameter may be supplied by the dataset multiplexer, such as from information 602 that is current at execution time. Capturing such information may enable an operational metadata module 528 (FIG. 5A), for example, to supply information to support additional facets of a search for a data.

In some examples, the values of one or more of these parameters may be obtained for a portion of the current context when a request is made to dataset multiplexer 105 to provide information for accessing a physical dataset. These parameters may be provided at the time the application is programmed or at the time the application is executed. They may be provided as labels to the dataset multiplexer 105 at the time of the data access operation is to be performed. In the example embodiment of FIG. 5A, these values may be provided through catalog services interface 522, for example.

FIG. 6 also illustrates that values of other parameters may be obtained without express user input and may be, for example, values of systems variables that otherwise exist within the data processing system. For example, FIG. 6 illustrates that the application is executing within an environment and a system variable may have a value indicating which environment. The value of that system variable may be used by dataset multiplexer 105 as part of the definition of the current context. Similarly, an application may have associated with it a system variable with the value indicating the type of the application. The value of that variable similarly may be used by dataset multiplexer 105 in selecting a physical dataset corresponding to a logical dataset in the current context.

FIG. 6 indicates that other system information may act as a label, which may be provided to dataset multiplexer 105 to serve as a portion of the current context information, which optionally may be used as a label instead of or in addition to the values of parameters as discussed above. The value of the label may be provided by another component of the data processing system, for example.

In the example of FIG. 6, dataset multiplexer 105 is shown to store third information 606 that is collected during execution of application 106-2. For example, third information 606 may include the date on which the dataset was accessed, the size of the dataset at the time it was accessed and/or the amount of data read to or written from the dataset, a host ID of computer hardware involved in data access such as by executing the application or access program or physically storing the data. Other portions of third information 606 may indicate the logical dataset associated with the output data store 620, the physical dataset accessed, values of parameters such as “Param1” and “Param2” supplied to program, when the physical dataset was accessed, and/or other information. Such an entry may be stored for each access to a dataset or for some number of prior accesses to a dataset or for a predetermined time after access to a dataset. This information may be analyzed after execution to determine other operational parameters, such as frequency or recency/freshness of use of the dataset.

Similar information may be stored for output data store 620. Upon execution of an operation to access a logical dataset associated with the output data store 620, context associated with the operation may be identified by dataset resolver 210 (such as because it is passed to the dataset resolver or collected by the dataset resolver). Based on the identified context, a record in the dataset catalog including context information that corresponds to the identified context may be selected and a DSG 625 associated with the selected record may be invoked. Invoking DSG 625 may result in its access logic and the conversion logic being executed. Upon execution, the output data store 620 may be accessed and data may be written to the output data store after converting from a format of the logical dataset to a format of the output data store and/or format of a corresponding physical dataset of the output data store. Parameters 640 represent parameters whose values are supplied to the controller module and may be utilized by DSG 625 during execution. Though not shown in FIG. 6, an entry in the repository of operational metadata may similarly be made based on access of a physical dataset corresponding to input data store 610.

### Representative Method of Accessing a Physical Dataset Based on Context

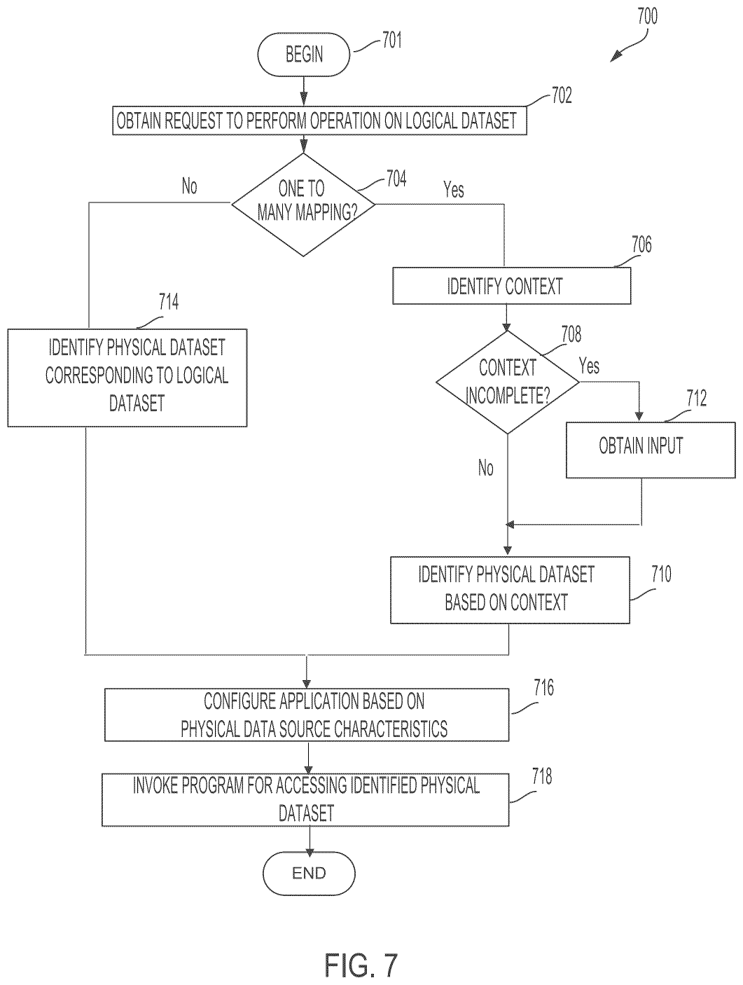

FIG. 7 is a flowchart of an illustrative process 700 for using objects in a dataset catalog, each with potentially multiple records for physical datasets with associated context related to a logical dataset to enable access to physical datasets in data stores, such that the physical dataset may be accessed from applications configured for access to logical datasets corresponding to the physical dataset. Process 700 may be executed by data processing system 104, such as in dataset multiplexer 105 described with reference to FIGS. 1A-1C and FIG. 2. Process 700 may alternatively or additionally include other acts, including acts as described elsewhere herein in connection with other embodiments.

Process 700 may begin 701 when an application configured for data access via a logical dataset is executed. As described above, executing such an application may generate a request to a dataset multiplexer to obtain information to access a physical dataset corresponding to the logical dataset that was used to program the application. That request may be received by the dataset multiplexer at act 702.

Processing may then proceed to decision block 704. At decision block 704, the dataset multiplexer may determine whether an object in the dataset catalog for the logical dataset specified in the request received at act 702 is associated with a one to many mapping between the specified logical dataset and multiple physical datasets. If not, processing may proceed to act 714, where the single physical dataset corresponding to the logical dataset may be identified. This physical dataset, for example, may be identified from the record associated with the object for the specified logical dataset.

Conversely, if it is determined at decision block 704 that the object in the dataset catalog for the specified logical dataset is associated with a mapping to multiple physical datasets, processing may branch to act 706 to begin a sub-process of identifying a single physical dataset based on context. That subprocess may begin at act 706 where the current context is identified. The dataset multiplexer may obtain all or a portion of the current context information from information maintained by the data processing system. Alternatively or additionally, all or a portion of the current context information may be provided as values of one of more parameters that pass from the execution environment to the dataset multiplexer. Those values, for example, may pass as part of the request received at act 702. In some examples, values of parameters obtained from information maintained by the data processing system may form system context information. Other context information that is unique to the executing application may be referred to as user context information. That user context information, for example, may be values of parameters specified by the user at the time the application was programmed or input at the time the application was executed. In some examples, the dataset multiplexer may obtain values of system context parameters from the components forming a portion of the data processing system separate from the application, whereas the user context information may be associated directly or indirectly with the application.

Regardless of the type and source(s) of the context information, processing may proceed to decision block 708 where a determination is made whether the identified context information is complete. In some examples, context information may be specified as values for a set with multiple parameters. Incomplete context information may be identified when one or more of the parameters lacks a value. Other approaches alternatively or additionally may be used to determine whether the context information is incomplete. For example, the check may be made in the data catalog to determine whether the available context information uniquely identifies a single physical dataset associated with the requested logical dataset.

If the information specifying the current context is not incomplete, processing may proceed to act 710. Conversely, if the information defining the current context is incomplete, processing may proceed to act 712 where a user may be prompted to specify missing context information. Such an approach may be used, for example, when the current context for selecting a physical dataset to access when executing an application includes a label with the value to be specified by a user at run time. Regardless of how the input identifying any missing context information is obtained at act 712, once the missing context information is obtained, processing may proceed to act 710.

The processing at decision block 708 and act 712 may be performed within the dataset multiplexer. Alternatively or additionally, processing to detect incomplete context information may be performed within the execution environment for an application. As one example, if a program is configured to provide a value of a parameter entered at execution time, the execution environment for the application may indicate incomplete context information if no value for that parameter has been input.

Regardless of which component identifies incomplete context information, once the current context information is complete, processing proceeds to act 710. At act 710, the dataset multiplexer may identify a physical dataset corresponding to the requested logical dataset based on the current context. Such an identification may be made based on matching, using exact or fuzzy matching techniques, the current context to a context specified for one of the multiple datasets mapped to the requested logical dataset in the dataset catalog.

In the example illustrated in FIG. 7, processing at act 710 or act 714 identifies a physical dataset corresponding to the requested logical dataset. Processing proceeds from either act 710 or 714 to act 716. At act 716 information in the dataset catalog associated with the identified physical dataset may be used to configure the application. As described above, a record in the dataset catalog for a physical dataset may include access information, such as a program and parameters for access. A link to the program or other information that enables the program element stored in the record for the identified physical dataset to be invoked for access to the appropriate physical dataset given the identified context.

In this example, the information for accessing the identified physical dataset is a program, which may be invoked at act 718 to access the physical dataset associated with the requested logical dataset in the current context.

The process 700 for handling a request to perform an operation specified in terms of a logical dataset may then end. It should be appreciated, however, that the process may be repeated multiple times as an application executes or a data processing system executes multiple applications. In some scenarios, a dataset multiplexer may process multiple requests to perform operations on a logical dataset. Notably, depending on the current context at the time each such request is received, a different physical dataset may be associated with the logical dataset. In this way complex operations may be readily performed with little programming burden on a user.

In some embodiments, act 704 may not be performed and processing from block 702 may proceed to blocks 706, 708, 712, 710, where a current context is identified and a physical dataset corresponding to the requested logical dataset is identified based on the current context. In some embodiments, when a single physical dataset is identified as corresponding to the logical dataset, information in the dataset catalog associated with the identified physical dataset may be used to configure the application. In some embodiments, when either no physical dataset or multiple physical datasets are identified as corresponding to the logical dataset, an error may be raised. For example, no physical dataset may be identified when the current context does not match with a context specified for the one of the multiple datasets mapped to the requested logical dataset. In another example, multiple physical datasets may be identified when the current context matches with a context specified for multiple datasets mapped to the requested logical dataset.

### Example User Interfaces

In some embodiments, when a logical dataset is mapped to multiple physical datasets, one or more user interfaces of a data processing system may include user interface elements through which a user may indicate that the resolution of the physical dataset corresponding to a logical dataset is to be limited to a subset of the multiple physical datasets mapped to the logical dataset in the dataset catalog. For example, a user may specify dataset access in terms of a logical dataset as part of writing an application program, as discussed in connection with FIG. 3B. The user interface may enable the user to define in connection with the designation of a logical dataset for dataset access, at least in part, a physical dataset. The user indication may be provided by indicating a subset of the multiple physical datasets from which a physical dataset will be selected for performing dataset access specified in terms of the logical dataset. In some examples, the user may specify a subset of physical datasets containing a single physical dataset. If a single physical dataset is indicated, it may act to override a selection of a physical dataset based on context in systems that are also configured to select a physical dataset based on context.

In some examples, a user of the data processing system may be able to invoke such a user interface, which may display information about some or all of the multiple physical data sets mapped to a logical dataset in the dataset catalog. These physical datasets may be presented in connection with user interface elements that enable a user to designate one or more of the physical datasets. That designation may be stored, for example, as an override parameter.

If a single physical dataset is specified as an override, the dataset multiplexer may use that designated override when selecting a physical dataset for performing access operations specified based on a logical dataset, without using any or some of the context information. In the example of FIG. 7, when a physical dataset is specified as an override, processing at acts 706, 710, 712 and at decision block 708 may be skipped, with processing proceeding to act 716 based on the physical dataset specified as part of the override. In examples in which a designated subset of physical datasets contains two or more physical datasets, processing at acts 706, 710, 712 and at decision block 708 may be performed, but the selection at act 710 may be made among the physical datasets in the designated subset.

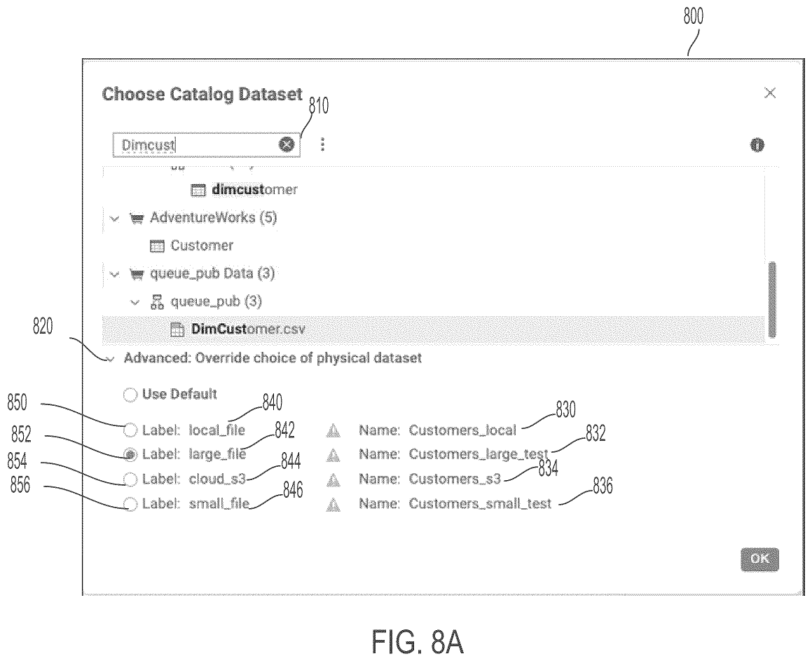

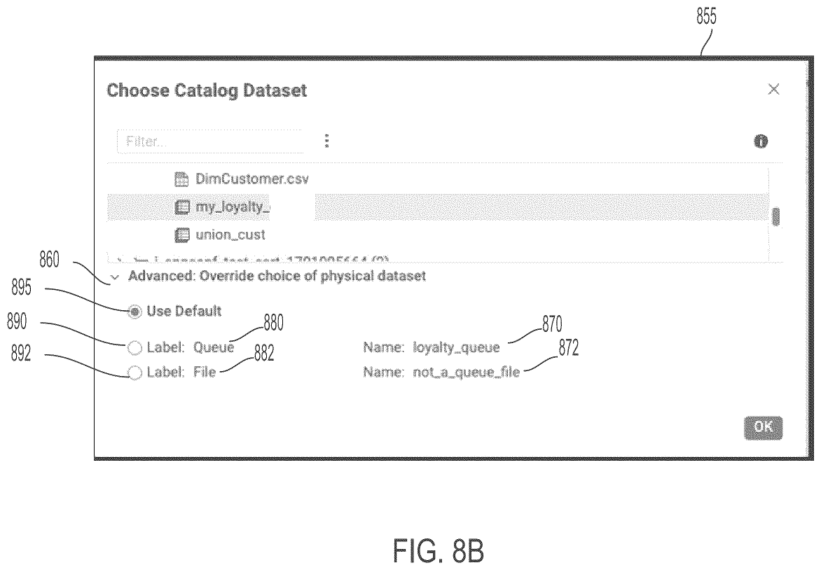

In some examples, user input may designate that one of multiple physical should be selected based on context information. In other examples, selection based on context may be the “Default” selection mode. In the example of FIG. 8A, selection based on context is the Default, but the user may designate a physical dataset to be used in place of a selection based on context. An interface as shown in FIG. 8A may be presented when dataset access is specified as part of writing an application program, at the time of execution of such an application program or at any other time during operation of the data processing system in which a user may be provided an option to indicate a physical dataset to be accessed to perform data access operations specified in terms of a logical dataset.

Information regarding the selection mode for a logical dataset may be stored in the entry/entries associated with the logical dataset in the dataset catalog. Absent user input indicating that the “Default” selection mode is to be overridden, in response to an indication that dataflow graph execution involves an operation on that logical dataset, the dataset multiplexer 105 may determine the physical dataset based on context. A user may override this default mode, for example, by specifying a particular physical dataset to be used during execution of an operation specified in terms of a logical dataset. For instance, multiple physical datasets mapped to the logical dataset may be presented to the user, enabling the user to select one as an override, as shown in FIG. 8A.

FIG. 8A illustrates an example user interface 800, which in this example is in a development environment. User interface 800 includes multiple user interface elements enabling a user to designate a logical datasets in a repository of logical datasets, such as a dataset catalog, and a selection mode for a corresponding physical dataset.

In the example of FIG. 8A, a logical dataset is determined based on user input. As shown in FIG. 8A, user interface 800 includes a user interface element 810 via which the user may input a search query specifying values or one or more dimensions (e.g., name) that describe a logical dataset. The data processing system may execute the search according to the query and return a list of options selected by the data processing system based on the query. Logical datasets may be presented as a list of options from which a user may make a selection. A selected logical dataset may then be used by the system to configure a component of the dataflow graph. FIG. 8A shows that a user has input as a search query as text string “Dimcust” in response to which the system has identified multiple logical datasets, including “DimCustomer.csv”. In the state shown, the user has made a selection of “DimCustomer.csv” from among the listed options.

Regardless of how and the purpose for which the logical dataset is determined, once determined, the user may provide further information that impacts the physical dataset accessed to perform dataset access specified in terms of that logical dataset. For example, object 820 may toggle between a selected or unselected state based on user input. When object 820 is selected, an advanced selection interface may be presented, as is shown in FIG. 8A. The advanced selection interface includes a listing of the multiple physical datasets 830, 832, 834, 836 mapped to the selected logical dataset along with their context information. As shown in FIG. 8A, the context information includes parameters that act as labels 840, 842, 844, 846. Labels 840 and 844 are “origin” labels that indicate an origin of the corresponding physical datasets 830 and 834. Labels 842 and 846 are “size” labels that indicate a size of the corresponding physical datasets 832 and 836.

In this example, the one to many mapping between the logical dataset “DimCustomer.csv” and the four physical datasets illustrated has already been input into the data processing system. This information may have been input, for example, by a different user than the user accessing the system through user interface 800. This information may be adequate for the data processing system, such as with a dataset multiplexer that resolves a one to many mapping based on context as elsewhere described herein, to select a physical data set automatically. Nonetheless, in some scenarios a user may wish to specify that for certain operations a specific physical dataset be used.

User interface elements 850, 852, 854, 856 enable a user to specify a particular physical dataset to be used during execution of an operation involving the logical dataset. A user may choose to override the default mode of selection of a physical dataset, for example, in response to a prompt when an application is executed or while an application is being developed. In the example of FIG. 8A, the user has selected user interface element 852 in an operating state in which an operation specified in terms of logical dataset “DimCustomer.csv” is to be performed, the dataset multiplexer 105 may select the user-specified physical dataset “Customers_large_test”. Dataset multiplexer 105 may obtain information for accessing this physical dataset, for example, from a catalog entry associated with logical dataset “DimCustomer.csv” and automatically provide that information for the data access operation.

FIG. 8B illustrates another example user interface 855 via which a user may alter the mode of selection of a physical dataset for performing operations specified in terms of a logical dataset. In this example, a user has identified a logical dataset “my_loyalty”, such as by making a selection from a list of logical datasets returned in response to a search query.

User interface 855 includes an advanced selection interface 860 depicting a listing of the multiple physical datasets 870, 872 mapped to the selected logical dataset “my_loyalty” along with their context information. As shown in FIG. 8B, the context information includes parameters that act as labels 880, 882. Labels 880 and 882 are labels indicating a type of data (e.g., continuous or queue versus batch or file) stored in the corresponding physical datasets. User interface elements 890, 892 enable a user to specify a particular physical dataset to be used during execution of an operation involving the logical dataset. That physical dataset may then be used, regardless of context at the time of access.

As shown in FIG. 8B, user interface element 895 also enables a user to select “Default.” The Default, for example, may be selection based on context information as elsewhere described herein. In other examples, however, the Default selection mode may be to use a specific physical dataset that has previously been designated as a Default. In this example, the “Default” physical dataset may be one of the datasets shown in advanced selection interface 860 or a different dataset.

According to some aspects, a data processing system may provide one or more user interfaces through which a user may obtain, input or change information about mappings between a logical dataset and one or more physical datasets. In some scenarios, interfaces through which information may be input or changed may be used by different users than the users who specify data access operations. Such a configuration, for example, enables users that have knowledge of the data environment of an enterprise to share it with users that wish to process that data. Conversely, users who are skilled at processing data within an enterprise to generate insights, can operate a data processing system with having that knowledge of the data environment.

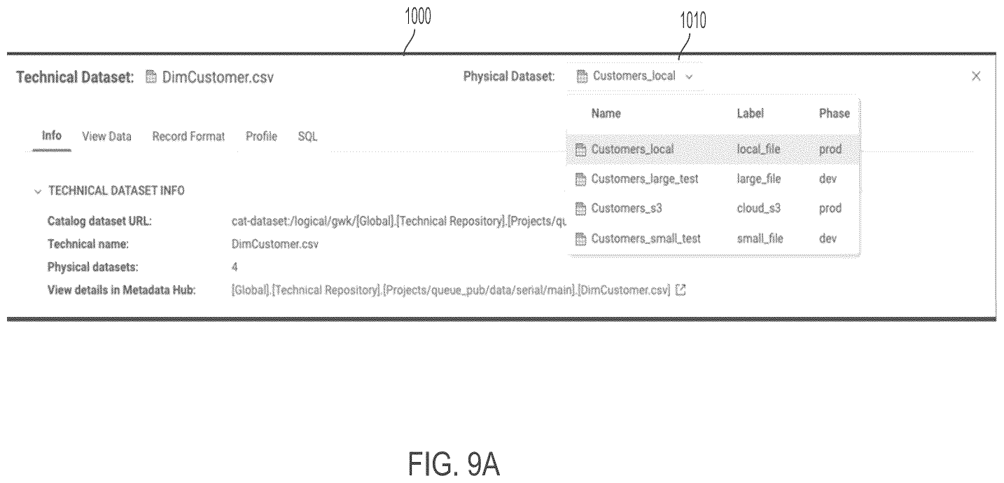

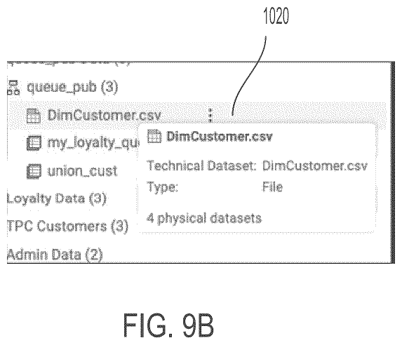

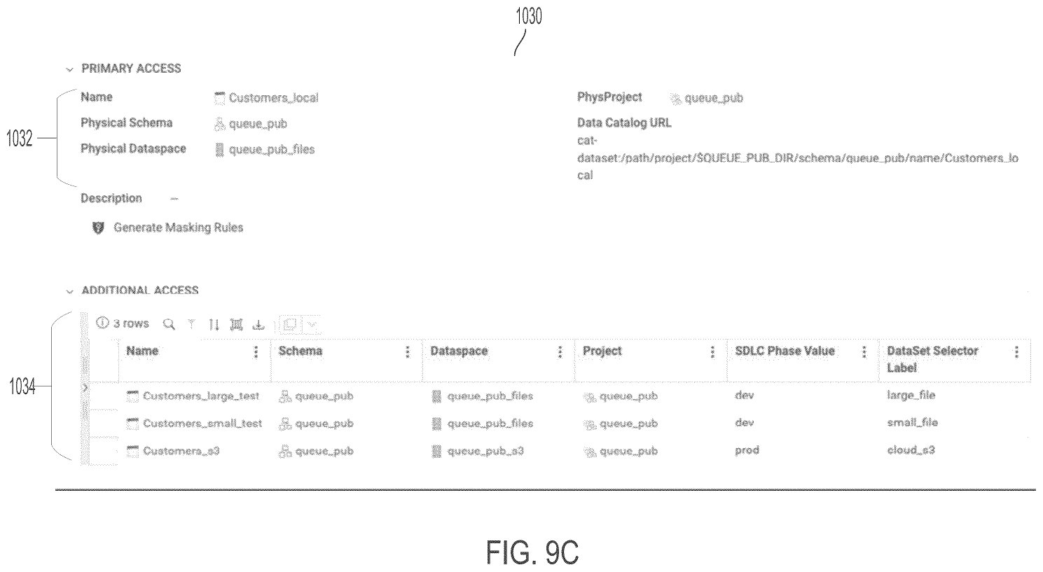

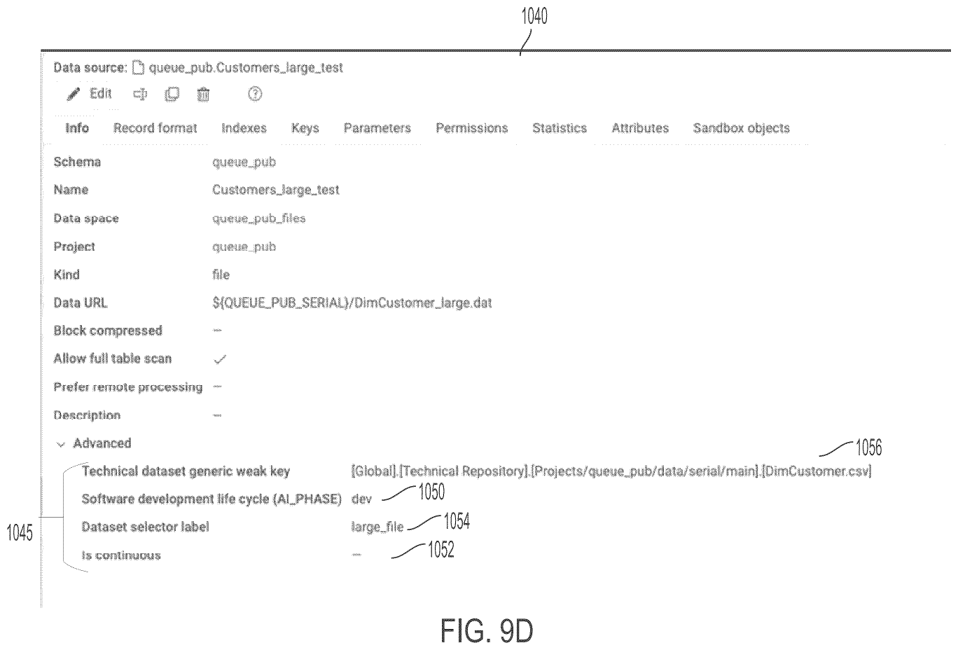

For example, when a logical dataset selected by the user is mapped to multiple physical datasets in the dataset catalog 107, one or more user interface elements shown in user interfaces of FIGS. 9A-9D may enable users to obtain information about such mappings. Some or all of the interface elements indicated may enable a user to input or change that information.

FIG. 9A is a user interface about a logical dataset, “DimCustomer.csv” in this example. As shown in FIG. 9A, a drop-down user interface element 1010 may be provided in user interface 1000, where the drop-down may show multiple (four in this example) physical datasets mapped to the logical dataset named “DimCustomer.csv” along with their context information. For example, the context information for each physical dataset may include labels indicating a size or origin associated with the physical dataset and an environment in which the physical dataset is used. As described elsewhere herein, this context information may be used to select among the mapped physical datasets for performing a data access operation specified in terms of the logical dataset.

FIG. 9B shows a tool tip graphical user interface 1020 which may be presented in response to a user's request to view additional information about a logical dataset. For example, additional information indicating a number of physical datasets mapped to the logical dataset may be obtained by selecting the logical dataset. As shown in FIG. 9B, the tool tip graphical user interface 1020 indicates that four physical datasets are mapped to the logical dataset “DimCustomer.csv”. In some embodiments, this tool tip graphical user interface may be presented in response to a user's request to view additional information about “DimCustomer.csv” presented in the listing of FIG. 8A. Such a selection, for example, may be made by a user hovering a mouse or other pointing device over the name of the logical dataset.

FIG. 9C is an example of a user interface in which information about the physical datasets mapped to a logical dataset may be input, modified or viewed. Such an interface may be invoked as part of the process of creating a dataset catalog entry for a logical dataset or in response to a search query, for example. In this example, a mapping between a logical dataset and multiple physical datasets may include a physical dataset that is used as a default, here designated as “Primary Access.” Additional physical datasets, identified in the section labeled “Additional Access,” are also mapped to the same logical dataset and a selection may be made from among these physical datasets when the default is not used.

FIG. 9C shows a portion 1030 of a user interface providing information about a logical dataset, such as logical dataset “DimCustomer.csv.” A top portion 1032 shows the physical dataset named “Customers_local” designated as the “Default” or primary physical dataset for the logical dataset. A bottom portion 1034 shows three other physical datasets mapped to the logical dataset. For each of these physical datasets, context information is also provided. For example, the context information for the physical dataset named “Customers_large_test” includes a label indicating a size (e.g., large) associated with the physical dataset and the environment (e.g., development) in which the physical dataset is used. Similarly, context information for the physical dataset named “Customers_small_test” includes a label indicating a size (e.g., small) associated with the physical dataset and the environment (e.g., development) in which the physical dataset is used. Also, context information for the physical dataset named “Customers_s3” includes a label indicating an origin (e.g., cloud) associated with the physical dataset and the environment (e.g., production) in which the physical dataset is used.

In this example, portion 1034 is presented as a table with user interface elements similar to those that may exist for searching, organizing or editing information in a spreadsheet. In this example, each physical dataset is described in a row of that table, such that additional physical datasets may be specified, for example, by adding rows to this table. Changes to the context or other information associated with the physical dataset may be made by editing values within cells of the corresponding row. Such user interface elements may be integrated into other user interfaces in which information about physical datasets is accessible.

FIG. 9D shows another example of a user interface 1040 that provides information about a physical dataset mapped to a logical dataset. As for the other user interfaces described herein, some or all of the user interface elements may be configured to enable a user to add, remove or modify information. At least some of the displayed information may be obtained from a record associated with the physical dataset in the dataset catalog. A portion 1045 of the user interface 1040 may indicate context information associated with the physical dataset. For example, portion 1045 includes values for three context parameters, environment 1050, application type 1052, and a size label 1054. The environment context parameter has the value “development.” The size label has the value “large_file”. The application type is indicated as continuous or batch based on an “is_continuous” indicator. A blank value, as shown in FIG. 9D, indicates that the application type is “batch” (i.e., not continuous). In some embodiments, the portion 1045 may also include an indication 1056 of the logical dataset that the physical dataset is mapped to.

### Additional Implementation Details

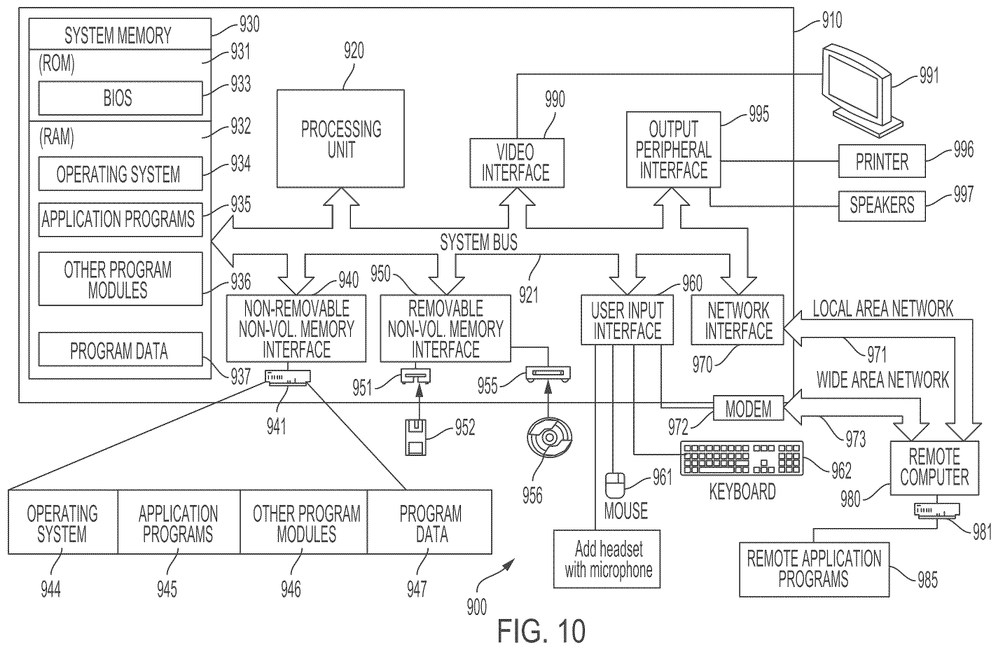

FIG. 10 illustrates an example of a suitable computing system environment 900 on which the technology described herein may be implemented. The computing system environment 900 is only one example of a suitable computing environment and is not intended to suggest any limitation as to the scope of use or functionality of the technology described herein. Neither should the computing environment 900 be interpreted as having any dependency or requirement relating to any one or combination of components illustrated in the exemplary operating environment 900.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 10, an exemplary system for implementing the technology described herein includes a general purpose computing device in the form of a computer 900. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 910. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable, volatile/nonvolatile computer storage media. By way of example only, FIG. 10 illustrates a hard disk drive 941 that reads from or writes to non-removable, nonvolatile magnetic media, a flash drive 951 that reads from or writes to a removable, nonvolatile memory 952 such as flash memory, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media described above and illustrated in FIG. 10, provide storage of computer readable instructions, data structures, program modules and other data for the computer 910. In FIG. 10, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. An actor may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the actor input interface 960, or other appropriate mechanism. In a networked environment, program modules depicted relative to the computer 910, or portions thereof, may be stored in the remote memory storage device. By way of example, and not limitation, FIG. 10 illustrates remote application programs 985 as residing on memory device 981. It will be appreciated that the network connections shown are exemplary and other means of establishing a communications link between the computers may be used.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

Having thus described several aspects of the technology described herein, it is to be appreciated that various alterations, modifications, and improvements are possible.

For example, it is described that a user writes applications that specify access to logical data. In some embodiments, the user may be a human user. In other embodiments, the user may be a program with artificial intelligence (an AI). The AI, for example, may derive data processing algorithms by processing a data set which may then be applied to other datasets.

As another example, catalog information about a physical dataset is described as stored in a record. It should be understood that such a term refers to information that can be related and does not imply any particular organization in memory. Further, information may partitioned and linked in other ways that achieve the functions described herein. For example, FIG. 4A illustrates context information 410 stored with various parameters for a physical dataset. In some implementations, there may be a copy of the parameters for each logical dataset entry in the catalog with which the physical dataset is associated. In other examples, the parameters may be stored once for each physical dataset, and that information may be linked to an entry corresponding to multiple logical datasets and context information defining when that physical dataset should be associated with that logical dataset.

As yet another example, a physical dataset was described as selected based on current context information upon specification of access to a logical dataset. In some examples, current context information may indicate context at the time access to the logical dataset is specified. In other examples, current context may refer to the context in which that access is be performed, e.g. access to a logical dataset may be associated with a job to be performed at a later time, and current context may refer to the context in which the job will be executed. In yet other examples, the selection of a physical dataset will be made dynamically, at the time the access occurs.

Further, various user interfaces were pictured and described, some of which were described as editable whereas others were described only in connection with presenting information that has been previously input into the data processing system. It should be appreciated that in other examples, any or all of the user interfaces may be configured to enable inputting, modifying and/or deleting information or, conversely, restricted to presenting information. In some data processing systems, the functionality enabled through each user interface may be configured based on user persona (e.g. role within an enterprise) to limit modification of information about physical datasets to only certain user with specialized knowledge or positions of trust, whereas access to this information may be made widely available to many users.

Also, dynamically using dataset catalog information for data access may additionally or alternatively automatically handle selection of appropriate physical datasets in the event of changes to storage of information associated with the logical dataset. The entry/entries associated with the logical dataset in the catalog of datasets may be updated in response to an event indicating a change to the storage of information associated with the logical dataset. Access of the physical datastore via the catalog information may ensure that the application continues to execute despite changes that might be made at any point throughout the IT system 100, even if the data analyst or other user who wrote the application was unaware of those changes. For example, a physical dataset may be migrated from one data store to another data store. The logical dataset that the application is programmed with need not be modified to account for this change. By updating the catalog entry/entries for the logical dataset, the dataset multiplexer may automatically utilize the updated catalog information to provide the application access to the correct physical dataset regardless of the data store in which it resides.

Such alterations, modifications, and improvements are intended to be part of this disclosure, and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described aspects of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. As used herein, the term “computer-readable storage medium” encompasses only a non-transitory computer-readable medium that can be considered to be a manufacture (i.e., article of manufacture) or a machine. Alternatively or additionally, aspects of the technology described herein may be embodied as a computer readable medium other than a computer-readable storage medium, such as a propagating signal.

The terms “program” or “software” are used herein in a generic sense to refer to any type of computer code or set of computer-executable instructions or processor-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor, but may be distributed in a modular fashion amongst a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIG. 8. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by an “actor” or a “user”. It should be appreciated that an “actor” or a “user” need not be a single individual, and that in some embodiments, actions attributable to an “actor” or a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, performed by a data processing system, for generating and/or using entries in a dataset catalog to enable access to physical datasets in data stores, wherein the data processing system is configured to execute data processing applications programmed to access logical datasets, the method comprising:
creating a plurality of records in the dataset catalog, wherein each record of the plurality of records is associated with a physical dataset and has associated therewith computer-executable instructions for accessing the physical dataset and at least two of the plurality of records are associated with a first logical dataset;
receiving input identifying, at least in part, the first logical dataset for accessing to perform an operation within a data processing application specifying access to a dataset;
upon execution of the operation within the data processing application:
selecting a record from the at least two of the plurality of records associated with the first logical dataset; and
invoking the computer-executable instructions for accessing a physical dataset associated with the selected record in the dataset catalog.

2. The method of claim 1, wherein each record of the plurality of records associated with a physical dataset comprises context information associated with the physical dataset.

3. The method of claim 2, wherein the context information comprises information identifying an environment in which the physical dataset is used.

4. The method of claim 3, wherein the information identifying the environment indicates one of a development environment, a test environment or a production environment.

5. The method of claim 2, wherein the context information comprises information identifying a type of a data processing application that accesses the physical dataset.

6. The method of claim 5, wherein the information identifying the type of the data processing application indicates one of a batch application or a continuous application.

7. The method of claim 2, wherein the context information comprises one or more labels.

8. The method of claim 7, wherein the one or more labels is a text string.

9. The method of claim 8, wherein the text string indicates a size of the physical dataset.

10. The method of claim 8, wherein the text string indicates origin information of the physical dataset.

11. The method of claim 2, wherein the context information comprises information identifying one or more users.

12. The method of claim 2, further comprising, for a record of the plurality of records associated with a physical dataset:
receiving the context information through a user interface; and
conditionally storing the received context information in the dataset catalog such that the context information is associated with the physical dataset.

13. The method of claim 12, wherein:
the physical dataset is associated in the dataset catalog with a logical dataset; and
conditionally storing the received context information in a record of the plurality of records in the dataset catalog comprises:
determining whether the dataset catalog contains a record associated with the logical dataset having the same context information;
storing the context information when it is determined that the dataset catalog does not contain a record associated with the logical dataset having the same context information; and
indicating an error when it is determined that the dataset catalog does contain a record associated with the logical dataset having the same context information.

14. The method of claim 1, wherein:
the at least two of the plurality of records associated with the first logical dataset comprises a first record associated with a first physical dataset and a second record associated with a second physical dataset,
the first record comprises first context information associated with the first physical dataset, and
the second record comprises second context information associated with the second physical dataset.

15. The method of claim 14, wherein selecting a record from the at least two of the plurality of records associated with the first logical dataset comprises:
identifying a context associated with the operation within the data processing application;
selecting the first record when the context associated with the operation corresponds to the first context information associated with the first physical dataset; and
selecting the second record when the context associated with the operation corresponds to the second context information associated with the second physical dataset.

16. The method of claim 15, further comprising:
identifying an ambiguity when both the first and the second records are identified for selection; and
providing a user interface through which a user provides input to resolve the ambiguity.

17. The method of claim 1, wherein invoking the computer-executable instructions comprises:
enabling access to the selected record in the dataset catalog; and
enabling access, based on information within the selected record, to a data store storing the physical dataset associated with the selected record in the dataset catalog.

18. A method for configuring a data processing system to facilitate access to a plurality of physical datasets in data stores, wherein the data processing system comprises a dataset multiplexer, the method comprising:
configuring the dataset multiplexer of the data processing system to provide an application with access to a physical dataset of the plurality of physical datasets at least in part by:
receiving information relating to the plurality of physical datasets stored in one or more data stores, wherein at least two of the plurality of physical datasets correspond to a first logical dataset;
receiving context information for each physical dataset of the plurality of physical datasets; and
storing the context information in a plurality of records in a dataset catalog, wherein each record of the plurality of records is associated with a physical dataset, and wherein storing the received context information comprises:
storing, in a first record in a dataset catalog, first context information for a first physical dataset of the at least two of the plurality of physical datasets; and
storing, in a second record in the dataset catalog, second context information for a second physical dataset of the at least two of the plurality of physical datasets.

19. The method of claim 18, wherein:
each of the plurality of records in the dataset catalog comprises a plurality of fields representing the context information; and
at least some of the plurality of fields are configured to store a value of a set of enumerated values.

20. The method of claim 19, wherein the plurality of fields comprises:
a first field configured to store a value from an enumerated set of values indicating a type of application;
a second field configured to store a value from an enumerated set of values indicating an environment of the data processing system; and
a third field configured to store a label.

21. The method of claim 18, wherein:
the dataset multiplexer comprises the dataset catalog storing information for access to the plurality of physical datasets.

22. The method of claim 18, wherein the first record further comprises a link to a first program to enable the application to access the first physical dataset with the first program and the second record further comprises a link to a second program to enable the application to access the second physical dataset with the second program.

23. The method of claim 22, wherein:
the first record further comprises values of parameters accessed in execution of the first program; and
the second record further comprises values of parameters accessed in execution of the second program.

24. A method, performed by a data processing system, for using entries in a dataset catalog to enable an application to access a plurality of physical datasets in a plurality of data stores, the method comprising:
providing a user interface through which a user identifies, at least in part, a logical dataset for accessing in the application; and
executing the application and, upon execution of an operation involving access to the identified logical data set:
selecting a record from at least two of a plurality of records associated with the logical dataset; and
enabling access, based on information within the selected record, to a data store storing the physical dataset associated with the selected record.

25. The method of claim 24, wherein:
the at least two of the plurality of records associated with the logical dataset comprises a first record associated with a first physical dataset and a second record associated with a second physical dataset,
the first record comprises first context information associated with the first physical dataset, and
the second record comprises second context information associated with the second physical dataset.

26. The method of claim 25, wherein selecting the record from the at least two of a plurality of records associated with the logical dataset comprises:
identifying a context associated with the operation involving access to the identified logical data set;
selecting the first record when the context associated with the operation corresponds to the first context information associated with the first physical dataset; and
selecting the second record when the context associated with the operation corresponds to the second context information associated with the second physical dataset.

27. The method of claim 26, wherein identifying a context associated with the operation involving access to the identified logical data set comprises:
prompting a user to provide input indicating a value of a parameter comprising a portion of the context associated with the operation.

28. The method of claim 27, wherein:
prompting the user to provide input indicating the value of a parameter comprising a portion of the context associated with the operation comprises presenting a list populated with values from the dataset catalog; and
the values from the dataset catalog are stored in records in the dataset catalog associated with the logical dataset.

29. The method of claim 26, wherein identifying a context associated with the operation involving access to the identified logical data set comprises:
providing a value indicative of an environment of the data processing system in which the application is invoked.

30. The method of claim 29, wherein the value indicative of the environment is one of development, test, or production.

31. The method of claim 26, wherein identifying a context associated with the operation involving access to the identified logical data set comprises:
providing a value indicative of a type of the application.

32. The method of claim 31, wherein the value indicative of the type of application is one batch or continuous.

33. The method of claim 27, identifying a context associated with the operation involving access to the identified logical data set comprises:
determining that a user specifiable parameter associated with the application lacks a value; and
based on the determination, prompting a user to provide input indicating a value of the user specifiable parameter.

34. The method of claim 24, wherein the selected record comprises context information associated with the physical dataset.

35. The method of claim 34, wherein the context information comprises at least a first type of context and a second type of context, and wherein selecting the record comprises:
determining whether to select the record based on evaluation of the first type of context; and
when the record is not selected based on the evaluation of the first type of context, determining whether to select the record based on evaluation of the second type of context.
